(19) United States
(12) Patent Application Publication
(10) Pub. No.: US 2025/0338180 A1
(43) Pub. Date: Oct. 30, 2025

(54) SYSTEM AND METHOD FOR CELLULAR NETWORK HANDOVER

(71) Applicant: The Board of Regents of the University of Oklahoma, Norman, OK (US)

(72) Inventors: Ali Imran, Bixby, OK (US); Marvin Manalastas, Tulsa, OK (US); Muhammad Umar Bin Farooq, Tulsa, OK (US); Syed Muhammad Asad Zaidi, Aubrey, TX (US)

(21) Appl. No.: 19/191,865

(22) Filed: Apr. 28, 2025

Related U.S. Application Data
(60) Provisional application No. 63/639,351, filed on Apr. 26, 2024.

(51) Int. Cl. H04W 36/00; H04L 41/5009; H04W 36/30

(52) U.S. Cl. CPC H04W 36/0058; H04L 41/5009; H04W 36/302

(57) ABSTRACT

Systems and methods for improving cellular handover performance are provided. A user individual offset parameter (UIO) is provided which may modify a measured signal strength parameter for a particular user equipment, improving handover performance. The UIO may be calculated and optimized such that one or more key performance indicators including signal to interference and noise ratio, handover success rate, and signaling overhead are maximized. A base station may compute or retrieve the value of a UIO for a particular user equipment, and adjust a measured signal strength and quality metric using the UIO. The UIO may be calculated either by the user equipment, the base station, or the core network.

### REFERENCE TO RELATED APPLICATIONS

The present patent application claims priority to U.S. provisional application No. 63/639,351, filed Apr. 26, 2024, entitled “USER INDIVIDUAL OFFSET (UIO): A NOVEL HANDOVER PARAMETER FOR NEXT-GENERATION CELLULAR NETWORKS”, which is hereby incorporated by reference in its entirety herein.

### BACKGROUND OF THE INVENTION

Each evolution of cellular networks aims to offer ubiquitous coverage and enhanced capacity to keep up with the escalating demand for mobile data traffic, with network densification emerging as the favored approach [1]. However, as the network expands to incorporate an array of base stations operating on diverse frequency bands, operators face a formidable challenge in managing mobility. The growing frequency of handovers leads to a heightened probability of handover failures (HOF), which can significantly impact user experience quality (QoE) metrics such as retainability, latency, and throughput, and also increase signaling load, thereby burdening the network [2].

To reduce the probability of handover failures (HOF) in cellular networks, operators can fine-tune handover-related configuration and optimization parameters (COPs) such as handover margin (HOM), time-to-trigger (TTT), and cell individual offset (CIO) [3]. Among these parameters, CIO offers greater flexibility as it is set on a per neighbor basis, unlike other parameters which are cell-specific. CIO is typically integrated into receive power measurement to regulate handover and determine cell association and coverage. By adjusting the CIO values, handover can be triggered earlier or later. Typically, CIO values are assigned positive or negative values, where a positive value virtually augments the Reference Signal Received Power (RSRP) or Reference Signal Received Quality (RSRQ) of the cell, and a negative value artificially reduces the RSRP or RSRQ of intended cells. CIO has been successful in addressing mobility-related issues by modifying handover decisions (such as accelerating handover to avoid delayed handovers or delaying handover to prevent too early or ping-pong handovers) [4]-[8].

Despite its usefulness, the inflexibility of CIO still poses several limitations. As CIO is configured per neighbor relation (i.e., from cell 1 to cell 2), it has limited influence over the specific user equipment (UE) that will be impacted by CIO adjustment. Therefore, modifying the CIO relationship between neighboring cells may result in favorable outcomes for some users, while adversely affecting others. For example, changing the CIO relationship between cells may result in unintended handovers to even stationary users. Furthermore, adjusting CIO to manage load balancing could potentially lead to congestion in the target cell, due to the limited control over the selection of UEs for handover. These limitations of CIO suggests that it may not be sufficient to meet the ever-growing demand for mobility in future networks.

Several studies have been conducted regarding more tailored and customized parameter settings. However, the benefits derived generally have come with significant drawbacks in terms of flexibility and customizability. One strategy entails user classification (i.e., using various machine learning and data mining techniques) followed by the customization of handover parameter settings to meet the specific requirements of each user class. Researchers in [9] utilized t-distributed stochastic neighbor embedding (t-SNE) and Density-Based Spatial Clustering of Applications with Noise (DBSCAN) to group users based on their reported RSRP from the source and neighboring base stations. The authors in [9] then adjusted the handover parameters based on the user groups, resulting in reduced call drop rates, decreased ping-pong handover rates, and an improved user experience. In another study [10], the authors used the Analytic Hierarchy Process and Technique for Order Preference by Similarity to Ideal Solution (AHP-TOPSIS) approach to determine the optimal base station for serving users. They also grouped the users based on their application needs, such as delay sensitivity and speed sensitivity, and used Q-learning to determine the ideal TTT and hysteresis settings to minimize handover issues like pingpong, late handover, and early handover. In [11], the authors employed machine learning techniques to identify unique patterns in the RSRP values reported by users during the handover process. Customized handover parameters were then applied to in-building base stations to improve the user experience. Similarly, in [12], users experiencing frequent handovers were classified as fast-moving or ping-pong users based on their mobility behavior, and tailored handover parameters were applied accordingly. In [13], a fuzzy logic-based approach was used to tune the handover hysteresis based on the user's velocity and radio channel quality. In [14], an algorithm was proposed to dynamically optimize handover parameters such as hysteresis and TTT based on user location, RSRP, signal to interference and noise ratio (SINR), and speed. The proposed algorithm aims to minimize handover failures and improve the success rate. Another proposed method in used an auto-tuning optimization (ATO) algorithm to modify handover parameters based on UE RSRP and speed, with the goal of reducing handover failures. Finally, in [16], the authors presented an adaptive handover mechanism that used a Kalman filter to estimate the future signal quality, state-action-reward-state-action (SARSA) based reinforcement learning to choose the target cell for the handover, and e-greedy policy to adjust the TTT and hysteresis.

Although most of the existing literature on handover management focuses on grouping users with similar behaviors, there are also studies that investigate individualized handover

optimization. For instance, in [17], the authors proposed an algorithm that dynamically adjusts handover settings for each user based on a weight function that considers factors such as SINR, cell load, and UE speed. By doing so, the proposed algorithm improved the RSRP, reduce ping pong handovers, and minimize radio link failures (RLFs).

Although the studies have proven effective in enhancing user mobility key performance indicators (KPIs), they have limitations in terms of customization. Specifically, methods under the first category only categorize users into clusters before applying handover parameter values, which restricts their flexibility. Additionally, updating parameters such as TTT and HOM whenever user

behavior changes, as proposed in [14]-[16], would significantly increase signaling overhead. It is also worth noting that none of the relevant publications proposed new parameters in either category, relying instead on existing ones such as HOM and TTT. As a result, these methods do not provide further optimization flexibility for cellular networks.

### SUMMARY OF THE INVENTION

To address limitations of the prior art, a novel handover parameter, referred to as User Individual Offset (UIO), is provided to complement the established and standardized CIO parameter. Although both CIO and UIO can influence handover decisions, CIO is configured per cell relation, while UIO is tailored to each user. This approach addresses the deficiencies of prior-art cellular handoff by offering greater flexibility in assigning handover parameter values and providing more precise control over handover operations. In some embodiments, the UIO value for each user is unique and determined by factors such as user velocity, trajectory, mobility pattern, and service requirements. By incorporating these factors, this system and method can optimize handovers for each user, thereby improving the overall network performance.

In general, in a first aspect, a base station may be provided which includes an RF transceiver, a controller/processor communicating with the RF transceiver, and a non-transitory computer readable medium storing computer executable instructions. When executed by the controller/processor, these instructions may cause the controller/processor to compute a value of a user individual offset parameter for a user device, determine a signal strength and quality measurement corresponding to a signal between the RF transceiver and the user device, and adjust the signal strength and quality measurement with the user individual offset parameter. The instructions may further cause the controller/processor to optimize the user individual offset parameter to maximize at least one key performance indicator such as signal to interference and noise ratio, handover success rate, and signaling overhead.

Adjustment of the signal strength and quality measurement may be accomplished by adding the user individual offset parameter to the signal strength and quality measurement or subtracting the user individual offset parameter from the signal strength and quality measurement. The signal strength and quality measurement is at least one of a group consisting of a received signal strength indicator, a received signal code power, a reference signal received power, a reference signal received quality, and signal to interference and noise ratio.

The instructions executed by the controller/processor may further cause the controller/processor to link the user individual offset parameter to an identifier associated with the user device. The instructions may cause the controller/processor to store the user individual offset parameter for the user in a database and overwrite a user individual offset for the user already in the database with a new user individual offset. In some implementations, instead of calculating a new user individual offset parameter, the instructions may cause the controller/processor to retrieve and use a previous user individual offset parameter from the database. The instructions may cause the controller/processor to determine that the adjusted signal strength and quality measurement has exceeded a handover threshold, and then initiate a handover request.

A method may be provided including determination of a user individual offset parameter for a user device, determination of a signal strength and quality measurement corresponding to a signal between an RF transceiver of a base station and the user device, and adjustment of the signal strength and quality measurement with the user individual offset parameter. The method may include optimization of the user individual offset parameter to maximize at least one key performance indicator, such as signal to interference and noise ratio, handover success rate, and signaling overhead.

Determination of a user individual offset parameter may involve either retrieval of the parameter from a database or computation of the parameter. The method may include storage of the user individual offset parameter in a database. The method may further include determination that the adjusted signal strength and quality measurement has exceeded a handover threshold and initiation of a handover request.

A core network may also be provided including an RF transceiver, a processor/controller, and a non-transitory computer readable medium storing computer executable instructions. The computer executable instructions may cause the processor to compute a value of a UIO and transmit, via the RF transceiver, the value of the UIO to one or more base stations.

The foregoing summary provides an overview of certain selected embodiments or embodiments disclosed herein, and is not intended to describe every aspect, embodiment, embodiment feature, or advantage of the disclosure exhaustively or comprehensively. Therefore, this summary should not be construed in such a way to limit the scope of this disclosure or to limit the scope of the claims. The details of one or more embodiments disclosed herein are set forth in the accompanying drawings and descriptions below. Other aspects, features, embodiments, embodiments, and advantages will become readily apparent in view of the description, the drawings, and the claims set forth herein.

Implementations of the above techniques include methods, apparatus, systems, and computer program products are described. One such computer program product is suitably embodied in a non-transitory computer-readable medium that stores instructions executable by one or more processors. The instructions are configured to cause the one or more processors to perform the above-described actions.

The details of one or more implementations of the subject matter of this specification are set forth in the accompanying drawings and the description below. Other aspects, features and advantages will become apparent from the description, the drawings, and the claims.

### BRIEF DESCRIPTION OF THE DRAWINGS

Several embodiments of the present disclosure are hereby illustrated in the appended drawings. It is to be noted however, that the appended drawings only illustrate several typical embodiments and are therefore not intended to be considered limiting of the scope of the present disclosure. Further, in the appended drawings, like or identical reference numerals or letters may be used to identify common or similar elements and not all such elements may be so numbered. The figures are not necessarily to scale and certain features and certain views of the figures may be shown as exaggerated in scale or in schematic in the interest of clarity and conciseness. For example, thicknesses and lengths are not limited to those shown in the drawings.

FIG. 1 is a block diagram illustrating a wireless telecommunication network in accordance with the present disclosure.

FIG. 2 is a block diagram illustrating architecture including 5G core network functions that can implement aspects of the present technology.

FIG. 3 depicts a system to analyze performance of a wireless telecommunication network in accordance with the present disclosure.

FIG. 4A is a block diagram illustrating an example of a user equipment in accordance with the present disclosure.

FIG. 4B is a block diagram illustrating an example of a base station in accordance with the present disclosure.

FIG. 5 is a block diagram illustrating an exemplary handover message flow in accordance with the present disclosure.

FIG. 6A is a block diagram illustrating an exemplary handover message flow with UIO generation by a base station in accordance with the present disclosure.

FIG. 6B is a block diagram illustrating an exemplary handover message flow with UIO generation by a user equipment in accordance with the present disclosure.

FIG. 7A is a diagram illustrating a handoff point for two users without UIO.

FIG. 7B is a diagram illustrating a handoff point for two users with a positive UIO implemented for the second user.

FIG. 7C is a diagram illustrating a handoff point for two users with a negative UIO implemented for the second user.

FIG. 8 is a diagram illustrating an exemplary effect on handover successes (HOS), handover failures (HOF), radio link failures (RLF) and handovers of static user with CIO not used and CIO optimized for particular users.

FIG. 9 is a diagram illustrating an exemplary UIO generation method in accordance with the present disclosure.

FIG. 10 is a diagram illustrating a map of RSRP traces in an exemplary telecommunications network deployment.

FIG. 11A is a diagram illustrating an effect of one user's optimal UIO on other users' mean signal to interference and noise ratio (SINR).

FIG. 11B is a diagram illustrating an effect of one user's optimal UIO on other users' signaling overhead (SigO).

FIG. 12 is a diagram illustrating an exemplary heat map of a UIO combination index against KPIs for users with differing speed and direction.

FIG. 13 is a graph illustrating a performance comparison of several machine learning with heuristic optimization approaches against brute force methods of generating UIO.

FIG. 14 is a graph illustrating a performance comparison between CIO-optimized and UIO-optimized wireless telecommunication networks.

### DETAILED DESCRIPTION

The present disclosure is directed to a telecommunication network in which a novel handoff parameter called the “user individual offset” or “UIO” is used by the base stations to allow for a user-specific handover threshold adjustment between neighboring base stations. The present disclosure addresses the prior-art problems caused by the inflexibility of the cell individual offset (“CIO”) by adjusting an offset parameter according to the needs and behavior of a particular user.

The following abbreviations may be used herein:
AHP-TOPSIS: Analytic Hierarchy Process and Technique for Order Preference by Similarity to Ideal Solution,
AI: Artificial intelligence,
AI/ML: Artificial Intelligence/Machine Learning
AF: Application Function
AMF: Access and Mobility management Function,
ATO: Auto-tuning optimization,
AUSF: Authentication Server Function,
BIS: Blind Interference Sensing,
BS: Base station,
CHF: Charging Function,
CIO: Cell Individual Offset,
COP: Configuration and optimization parameter,
CQI: Channel Quality Indicator,
CSG: Closed subscriber group,
CUPS: Control and User Plane Separation,
DBSCAN: Density-Based Spatial Clustering of Applications with Noise
DL: Downlink
DN: Data network,
DT: Digital twin,
DTM: Digital Terrain Model,
E2E: End-to-end,
eNB: enhanced Node B,
FDD: Frequency division duplex,
GA: Genetic algorithm,
GNN: Graph Neural Network,
HARQ: Hybrid ARQ,
HOM: Handover Margin,
HOSR: Handover success rate,
HSS: Home Subscriber Server,
Hyst: Hysteresis,
IEEE: Institute of Electrical and Electronics Engineers,
IoT: Internet-of-Things,
IP: Internet protocol,
KPI: Key Performance Indicator,
LTE: Long Term Evolution,
LTE-A: Long Term Evolution Advanced,
MAC: Medium Access Control,
MBB: Mobile broadband,
MIMO: Multiple input, multiple output,
ML: Machine learning,
MRO: Mobility Robustness Optimization,
Mserv: Measured signal strength of serving cell,
Mtar: Measured signal strength of target cell,
MTC: Machine-type communication,
MVNO: Mobile Virtual Network Operator,
M2M: Machine-to-machine
M2X: Machine-to-everything,
NAN: Network access node,
NEF: Network Exposure Function,
NR: New radio,
NRF: NF Repository Function,
NSSF: Network Slice Selection Function,
NTN: Non-Terrestrial Network,
OAM: Operations and Management Layer,
Off: Offset parameter,
Oserv,cell: Serving cell-specific offset,
Oserv,freq: Serving frequency-specific offset,
Otar,cell: Target cell-specific offset,
Otar,freq: Target frequency-specific offset,
PCF: Policy Control Function,
PDCP: Packet Data Convergence Protocol,
PRB: Physical resource block,
QoS: Quality of service,
RAN: Radio Access Network,
RIC: RAN Intelligent Controller,
RLF: Radio Link Failure,
RMSE: Root Mean Square Error,
RRC: Radio Resource Control,
RSPR: Reference Signal Received Power,
RSRQ: Reference Signal Received Quality,
RT: Real-time,
SARSA: State-action-reward-state-action,
SBA: Server Based Architecture,
SBC: Single-board computer system,
SBI: Server Based Interface,
SCP: Service Communication Proxy,
SigO: Signaling Overhead,
SINR: Signal to Interference plus Noise Ratio,
SOC: System-on-chip,
SON: Self-organizing network,
SMF: Session Management Function,
SMO: Service Management and Orchestration,
SMS: Short message service,
S-NSSAI: Single Network Slice Selection Assistance Information,
TDD: Time division duplex,
THz: Terahertz,
TN: Terrestrial Network,
t-SNE: t-distributed stochastic neighbor embedding,
TTT: Time-to-trigger,
UDC: User Data Convergence,
UDM: Unified Data Management,
UDR: User Data Repository,
UE: User Equipment,
UIO: User Individual Offset,
UIOO: Optimal User Individual Offset,
UL: Uplink
UPF: User Plane Function,
URLLC: Ultra-reliable low-latency communication,
V2X: Vehicle-to-everything,
WLAN: Wireless local area network,
3GPP: 3^{rd} Generation Partnership Project,
5G: Fifth generation,
6G: Sixth generation.

Before further describing various embodiments of the present disclosure in more detail by way of exemplary description, examples, and results, it is to be understood that the embodiments of the present disclosure are not limited in structure and application to the details as set forth in the following description. The embodiments of the present disclosure are capable of being practiced or carried out in various ways not explicitly described herein. As such, the language used herein is intended to be given the broadest possible scope and meaning; and the embodiments are meant to be exemplary, not exhaustive. Also, it is to be understood that the phraseology and terminology employed herein is for the purpose of description and should not be regarded as limiting unless otherwise indicated as so. Moreover, in the following detailed description, numerous specific details are set forth in order to provide a more thorough understanding of the disclosure. However, it will be apparent to a person having ordinary skill in the art that the embodiments of the present disclosure may be practiced without these specific details. In other instances, features which are well known to persons of ordinary skill in the art have not been described in detail to avoid unnecessary complication of the description. While the present disclosure has been described in terms of particular embodiments, it will be apparent to those of skill in the art that variations may be applied to the apparatus and/or methods and in the steps or in the sequence of steps of the methods described herein without departing from the concept, spirit, and scope of the inventive concepts as described herein. All such similar substitutes and modifications apparent to those having ordinary skill in the art are deemed to be within the spirit and scope of the inventive concepts as disclosed herein.

All patents, published patent applications, and non-patent publications referenced or mentioned in any portion of the present specification are indicative of the level of skill of those skilled in the art to which the present disclosure pertains, and are hereby expressly incorporated by reference in their entirety to the same extent as if the contents of each individual patent or publication was specifically and individually incorporated herein. In particular, U.S. Provisional Ser. No. 63/639,351, filed Apr. 26, 2024, is expressly incorporated herein by reference, in its entirety.

Unless otherwise defined herein, scientific and technical terms used in connection with the present disclosure shall have the meanings that are commonly understood by those having ordinary skill in the art. Further, unless otherwise required by context, singular terms shall include pluralities and plural terms shall include the singular.

As utilized in accordance with the apparatus, methods and compositions of the present disclosure, the following terms, unless otherwise indicated, shall be understood to have the following meanings:

The use of the word “a” or “an” when used in conjunction with the term “comprising” in the claims and/or the specification may mean “one,” but it is also consistent with the meaning of “one or more,” “at least one,” and “one or more than one.” The use of the term “or” in the claims is used to mean “and/or” unless explicitly indicated to refer to alternatives only or when the alternatives are mutually exclusive, although the disclosure supports a definition that refers to only alternatives and “and/or.”

The use of the terms “at least one” or “plurality” will be understood to include one as well as any quantity more than one, including but not limited to, 2, 3, 4, 5, 6, 7, 8, 9, 10, 15, 20, 30, 40, 50, 100, or any integer inclusive therein, and/or any range described herein. The terms “at least one” or “plurality” may extend up to 100 or 1000 or more, depending on the term to which it is attached; in addition, the quantities of 100/1000 are not to be considered limiting, as higher limits may also produce satisfactory results. In addition, the use of the term “at least one of x, y and z” will be understood to include x alone, y alone, and z alone, as well as any combination of x, y and z.

As used in this specification and claims, the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The term “or combinations thereof” as used herein refers to all permutations and combinations of the listed items preceding the term. For example, “a, b, c, or combinations thereof” is intended to include at least one of: a, b, c, ab, ac, bc, or abc, and if order is important in a particular context, also ba, ca, cb, cba, bca, acb, bac, or cab. Continuing with this example, expressly included are combinations that contain repeats of one or more item or term, such as bb, aaa, aab, bbc, aaabcccc, cbbaaa, cababb, and so forth. The skilled artisan will understand that typically there is no limit on the number of items or terms in any combination, unless otherwise apparent from the context.

Throughout this application, the terms “about” and “approximately” are used to indicate that a value includes the inherent variation of error for the composition, the method used to administer the composition, or the variation that exists among the objects, or study subjects. As used herein the qualifiers “about” or “approximately” are intended to include not only the exact value, amount, degree, orientation, or other qualified characteristic or value, but are intended to include some slight variations due to measuring error, manufacturing tolerances, stress exerted on various parts or components, observer error, wear and tear, and combinations thereof, for example. The terms “about” or “approximately”, where used herein when referring to a measurable value such as an amount, a temporal duration, thickness, width, length, and the like, is meant to encompass, for example, variations of ±20% or ±10%, or ±5%, or ±1%, or ±0.1% from the specified value, as such variations are appropriate to perform the disclosed methods and as understood by persons having ordinary skill in the art. As used herein, the term “substantially” means that the subsequently described event or circumstance completely occurs or that the subsequently described event or circumstance occurs to a great extent or degree. For example, the term “substantially” means that the subsequently described event or circumstance occurs at least 75% of the time, at least 80% of the time, at least 90% of the time, at least 95% of the time, or at least 98% of the time.

As used herein any reference to “one embodiment” or “an embodiment” means that a particular clement, feature, structure, or characteristic described in connection with the embodiment is included in at least one embodiment. The appearances of the phrase “in one embodiment” in various places in the specification are not necessarily all referring to the same embodiment.

As used herein, all numerical values or ranges include fractions of the values and integers within such ranges and fractions of the integers within such ranges unless the context clearly indicates otherwise. Thus, to illustrate, reference to a numerical range, such as 1-10 includes 1, 2, 3, 4, 5, 6, 7, 8, 9, 10, as well as 1.1, 1.2, 1.3, 1.4, 1.5, etc., and so forth. Reference to a range of 1-30therefore includes 1, 2, 3, 4, 5, 6, 7, 8, 9, 10, 11, 12, 13, 14, 15, 16, 17, 18, 19, 20, 21, 22, 23, 24, 25, 26, 27, 28, 29, and 30, as well as sub-ranges within the greater range, e.g., for 1-30, sub-ranges include but are not limited to 1-10, 2-15, 2-25, 3-30, 10-20, and 20-30. Reference to a range of 1 -50 therefore includes 1, 2, 3, 4, 5, 6, 7, 8, 9, 10, 11, 12, 13, 14, 15, 16, 17, 18, 19, 20, 21, 22, 23, 24, 25, 26, 27, 28, 29, and 30, etc., up to and including 50. Reference to a series of ranges includes ranges which combine the values of the boundaries of different ranges within the series. Thus, to illustrate reference to a series of ranges, for example, a range of 1-1,000 includes, but is not limited to, 1-10, 2-15, 2-25, 3-30, 10-20, 20-30, 30-40, 40-50, 50-60, 60-75, 75-100, 100 -150, 150-200, 200-250, 250-300, 300-400, 400-500, 500-750, 750-1,000, and includes ranges of 1-20, 10-50, 50-100, 100-500, and 500-1,000. The range 1 mm to 10 m therefore refers to and includes all values or ranges of values, and fractions of the values and integers within said range, including for example, but not limited to, 5 mm to 9 m, 10 mm to 5 m, 10 mm to 7.5 m, 7.5 mm to 8 m, 20 mm to 6 m, 15 mm to 1 m, 31 mm to 800 cm, 50 mm to 500 mm, 4 mm to 2.8 m, and 10 cm to 150 cm. Any two values within the range of 1 mm to 10 m therefore can be used to set a lower and an upper boundaries of a range in accordance with the embodiments of the present disclosure.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

The inventive concepts of the present disclosure will be more readily understood by reference to the following examples and embodiments, which are included merely for purposes of illustration of certain aspects and embodiments thereof, and are not intended to be limitations of the disclosure in any way whatsoever. Those skilled in the art will promptly recognize appropriate variations of the apparatus, compositions, components, procedures and method shown below.

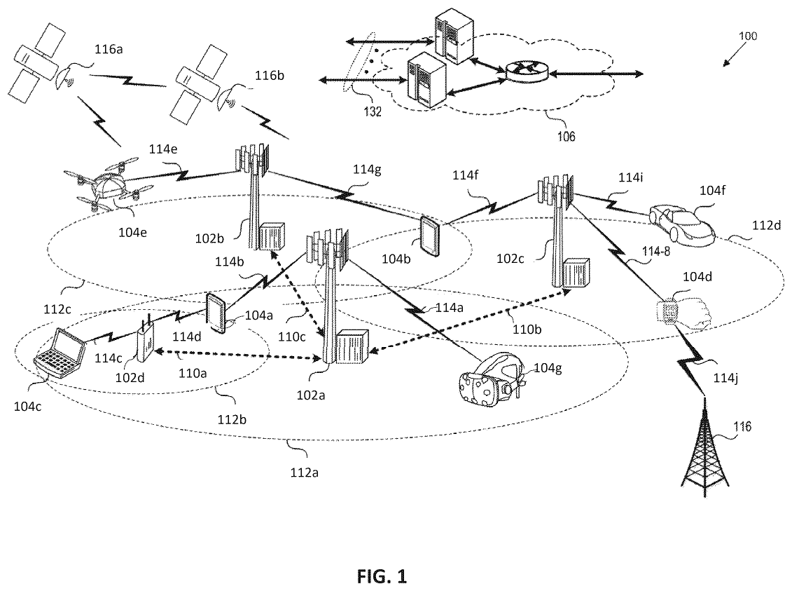

FIG. 1 is a block diagram that illustrates a wireless telecommunication network 100 (“network 100”) in which aspects of the disclosed technology are incorporated. The network 100 includes base stations 102a through 102d (also referred to individually as “base station 102” or collectively as “base stations 102”). A base station is a type of network access node (NAN) that can also be referred to as a cell site, a base transceiver station, or a radio base station. The network 100 can include any combination of NANs including an access point, radio transceiver, gNodeB (gNB), NodeB, cNodeB (NB), Home NodeB or Home eNodeB, or the like. In addition to being a wireless wide area network (WVAN) base station, a NAN can be a wireless local area network (WLAN) access point, such as an Institute of Electrical and Electronics Engineers (IEEE) 802.11 access point.

The NANs of a network 100 formed by the network 100 also include wireless devices 104a through 104g (referred to individually as “wireless device 104” or collectively as “wireless devices 104”) and a core network 106. The wireless devices 104a through 104g can correspond to or include network 100 entities capable of communication using various connectivity standards. For example, a 5G communication channel can use millimeter wave (mmW) access frequencies of 28 GHz or more. In some implementations, the wireless device 104 can operatively couple to a base station 102 over a long-term evolution/long-term evolution-advanced (LTE/LTE-A) communication channel, which is referred to as a 4G communication channel.

The core network 106 provides, manages, and controls security services, user authentication, access authorization, tracking, Internet Protocol (IP) connectivity, and other access, routing, or mobility functions. The base stations 102 interface with the core network 106 through a first set of backhaul links (e.g., S1 interfaces) and can perform radio configuration and scheduling for communication with the wireless devices 104 or can operate under the control of a base station controller (not shown). In some examples, the base stations 102 can communicate with each other, either directly or indirectly (e.g., through the core network 106), over a second set of backhaul links 110a through 110c (e.g., X1 interfaces), which can be wired or wireless communication links.

The base stations 102 can wirelessly communicate with the wireless devices 104 via one or more base station antennas. The cell sites can provide communication coverage for geographic coverage areas 112a through 112d (also referred to individually as “coverage area 112” or collectively as “coverage areas 112”). The geographic coverage area 112 for a base station 102 can be divided into sectors making up only a portion of the coverage area (not shown). The network 100 can include base stations of different types (e.g., macro and/or small cell base stations). In some implementations, there can be overlapping geographic coverage areas 112 for different service environments (e.g., Internet-of-Things (IoT), mobile broadband (MBB), vehicle-to-everything (V2X), machine-to-machine (M2M), machine-to-everything (M2X), ultra-reliable low-latency communication (URLLC), machine-type communication (MTC), etc.).

The network 100 can include a 5G network 100 and/or an LTE/LTE-A or other network. In an LTE/LTE-A network, the term eNB is used to describe the base stations 102, and in 5G new radio (NR) networks, the term gNBs is used to describe the base stations 102 that can include mmW communications. The network 100 can thus form a heterogeneous network 100 in which different types of base stations provide coverage for various geographic regions. For example, each base station 102 can provide communication coverage for a macro cell, a small cell, and/or other types of cells. As used herein, the term “cell” can relate to a base station, a carrier or component carrier associated with the base station, or a coverage area (e.g., sector) of a carrier or base station, depending on context.

A macro cell generally covers a relatively large geographic area (e.g., several kilometers in radius) and can allow access by wireless devices that have service subscriptions with a wireless network 100 service provider. As indicated earlier, a small cell is a lower-powered base station, as compared to a macro cell, and can operate in the same or different (e.g., licensed, unlicensed) frequency bands as macro cells. Examples of small cells include pico cells, femto cells, and micro cells. In general, a pico cell can cover a relatively smaller geographic area and can allow unrestricted access by wireless devices that have service subscriptions with the network 100 provider. A femto cell covers a relatively smaller geographic area (e.g., a home) and can provide restricted access by wireless devices having an association with the femto unit (e.g., wireless devices in a closed subscriber group (CSG), wireless devices for users in the home). A base station can support one or multiple (e.g., two, three, four, and the like) cells (e.g., component carriers). All fixed transceivers noted herein that can provide access to the network 100 are NANs, including small cells.

The communication networks that accommodate various disclosed examples can be packet-based networks that operate according to a layered protocol stack. In the user plane, communications at the bearer or Packet Data Convergence Protocol (PDCP) layer can be IP-based. A Radio Link Control (RLC) layer then performs packet segmentation and reassembly to communicate over logical channels. A Medium Access Control (MAC) layer can perform priority handling and multiplexing of logical channels into transport channels. The MAC layer can also use Hybrid ARQ (HARQ) to provide retransmission at the MAC layer, to improve link efficiency. In the control plane, the Radio Resource Control (RRC) protocol layer provides establishment, configuration, and maintenance of an RRC connection between a wireless device 104 and the base stations 102 or core network 106 supporting radio bearers for the user plane data. At the Physical (PHY) layer, the transport channels are mapped to physical channels.

Wireless devices 104 can be integrated with or embedded in other devices. As illustrated, the wireless devices 104 are distributed throughout the network 100, where each wireless device 104 can be stationary or mobile. For example, wireless devices can include handheld mobile devices 104a and 104b (e.g., smartphones, portable hotspots, tablets, etc.); laptops 104c; wearables 104d; drones 104c; vehicles with wireless connectivity 104f; head-mounted displays with wireless augmented reality/virtual reality (ARNR) connectivity 104g; portable gaming consoles; wireless routers, gateways, modems, and other fixed-wireless access devices; wirelessly connected sensors that provide data to a remote server over a network; IoT devices such as wirelessly connected smart home appliances, etc.

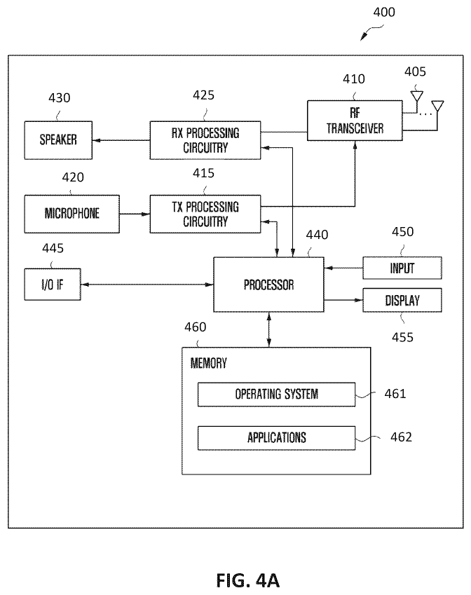

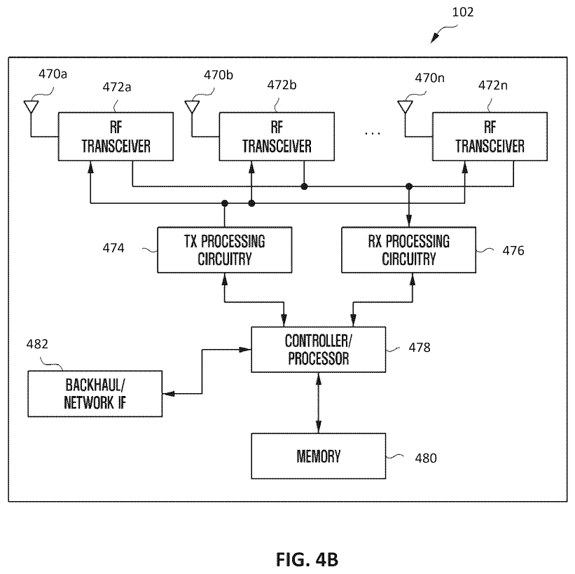

A wireless device 104 (e.g., wireless devices 104a, 104b, 104c, 104d, 104c, 104f, and 104g) can be referred to as a user equipment 400 (FIG. 4) (UE), a customer premise equipment (CPE), a mobile station, a subscriber station, a mobile unit, a subscriber unit, a wireless unit, a remote unit, a handheld mobile device, a remote device, a mobile subscriber station, terminal equipment, an access terminal, a mobile terminal, a wireless terminal, a remote terminal, a handset, a mobile client, a client, or the like.

A wireless device 104 can communicate with various types of base stations and network 100 equipment at the edge of a network 100 including macro eNBs/gNBs, small cell eNBs/gNBs, relay base stations, and the like. A wireless device can also communicate with other wireless devices either within or outside the same coverage area of a base station via device-to-device (D2D) communications.

The communication links 114a through 114i (also referred to individually as “communication link 114” or collectively as “communication links 114”) shown in network 100 include uplink (UL) transmissions from a wireless device 104 to a base station 102, and/or downlink (DL) transmissions from a base station 102 to a wireless device 104. The downlink transmissions can also be called forward link transmissions while the uplink transmissions can also be called reverse link transmissions. Each communication link 114 includes one or more carriers, where each carrier can be a signal composed of multiple sub-carriers (e.g., waveform signals of different frequencies) modulated according to the various radio technologies. Each modulated signal can be sent on a different sub-carrier and carry control information (e.g., reference signals, control channels), overhead information, user data, etc. The communication links 114 can transmit bidirectional communications using frequency division duplex (FDD) (e.g., using paired spectrum resources) or time division duplex (TDD) operation (e.g., using unpaired spectrum resources). In some implementations, the communication links 114 include LTE and/or mmW communication links.

In some implementations of the network 100, the base stations 102 and/or the wireless devices 104 include multiple antennas for employing antenna diversity schemes to improve communication quality and reliability between base stations 102 and wireless devices 104. Additionally or alternatively, the base stations 102 and/or the wireless devices 104 can employ multiple-input, multiple-output (MIMO) techniques that can take advantage of multi-path environments to transmit multiple spatial layers carrying the same or different coded data.

In some examples, the network 100 implements 6G technologies including increased densification or diversification of network nodes. The network 100 can enable terrestrial and non-terrestrial transmissions. In this context, a Non-Terrestrial Network (NTN) is enabled by one or more satellites such as satellites 116a and 116b to deliver services anywhere and anytime and provide coverage in areas that are unreachable by any conventional Terrestrial Network (TN). A 6G implementation of the network 100 can support terahertz (THz) communications. This can support wireless applications that demand ultrahigh quality of service requirements and multi-terabits per second data transmission in the 6G and beyond era, such as terabit-per-second backhaul systems, ultrahigh-definition content streaming among mobile devices, ARNR, and wireless high-bandwidth secure communications. In another example of 6G, the network 100 can implement a converged Radio Access Network (RAN) and Core architecture to achieve Control and User Plane Separation (CUPS) and achieve extremely low User Plane latency. In yet another example of 6G, the network 100 can implement a converged Wi-Fi and Core architecture to increase and improve indoor coverage.

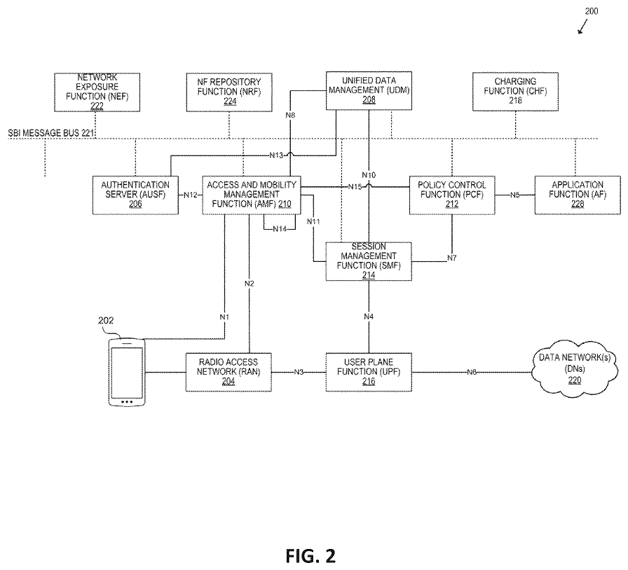

FIG. 2 is a block diagram that illustrates an architecture 200 including 5G core network functions (NFs) that can implement aspects of the present technology. A wireless device 202 can access the 5G network through a NAN (e.g., gNB) of a RAN 204. The NFs include an Authentication Server Function (AUSF) 206, a Unified Data Management (UDM) 208, an Access and Mobility management Function (AMF) 210, a Policy Control Function (PCF) 212, a Session Management Function (SMF) 214, a User Plane Function (UPF) 216, and a Charging Function (CHF) 218.

The interfaces N1 through N15 define communications and/or protocols between each NF as described in relevant standards. The UPF 216 is part of the user plane and the AMF 210, SMF 214, PCF 212, AUSF 206, and UDM 208 are part of the control plane. One or more UPFs can connect with one or more data networks (DNs) 220. The UPF 216 can be deployed separately from control plane functions. The NFs of the control plane are modularized such that they can be scaled independently. As shown, each NF service exposes its functionality in a Service Based Architecture (SBA) through a Service Based Interface (SBI) 221 that uses HTTP/2. The SBA can include a Network Exposure Function (NEF) 222, an NF Repository Function (NRF) 224, a Network Slice Selection Function (NSSF) 226, and other functions such as a Service Communication Proxy (SCP).

The SBA can provide a complete service mesh with service discovery, load balancing, encryption, authentication, and authorization for interservice communications. The SBA employs a centralized discovery framework that leverages the NRF 224, which maintains a record of available NF instances and supported services. The NRF 224 allows other NF instances to subscribe and be notified of registrations from NF instances of a given type. The NRF 224 supports service discovery by receipt of discovery requests from NF instances and, in response, details which NF instances support specific services.

The NSSF 226 enables network slicing, which is a capability of 5G to bring a high degree of deployment flexibility and efficient resource utilization when deploying diverse network services and applications. A logical end-to-end (E2E) network slice has predetermined capabilities, traffic characteristics, and service-level agreements, and includes the virtualized resources required to service the needs of a Mobile Virtual Network Operator (MVNO) or group of subscribers, including a dedicated UPF, SMF, and PCF. The wireless device 202 is associated with one or more network slices, which all use the same AMF. A Single Network Slice Selection Assistance Information (S-NSSAI) function operates to identify a network slice. Slice selection is triggered by the AMF, which receives a wireless device registration request. In response, the AMF retrieves permitted network slices from the UDM 208 and then requests an appropriate network slice of the NSSF 226.

The UDM 208 introduces a User Data Convergence (UDC) that separates a User Data Repository (UDR) for storing and managing subscriber information. As such, the UDM 208 can employ the UDC under 3GPP TS 22.101 to support a layered architecture that separates user data from application logic. The UDM 208 can include a stateful message store to hold information in local memory or can be stateless and store information externally in a database of the UDR. The stored data can include profile data for subscribers and/or other data that can be used for authentication purposes. Given a large number of wireless devices that can connect to a 5G network, the UDM 208 can contain voluminous amounts of data that is accessed for authentication. Thus, the UDM 208 is analogous to a Home Subscriber Server (HSS), serving to provide authentication credentials while being employed by the AMF 210 and SMF 214 to retrieve subscriber data and context.

The PCF 212 can connect with one or more application functions (AFs) 228. The PCF 212 supports a unified policy framework within the 5G infrastructure for governing network behavior. The PCF 212 accesses the subscription information required to make policy decisions from the UDM 208, and then provides the appropriate policy rules to the control plane functions so that they can enforce them. The SCP (not shown) provides a highly distributed multi-access edge compute cloud environment and a single point of entry for a cluster of network functions, once they have been successfully discovered by the NRF 224. This allows the SCP to become the delegated discovery point in a datacenter, offloading the NRF 224 from distributed service meshes that make up a network operator's infrastructure. Together with the NRF 224, the SCP forms the hierarchical 5G service mesh.

The AMF 210 receives requests and handles connection and mobility management while forwarding session management requirements over the N11 interface to the SMF 214. The AMF 210 determines that the SMF 214 is best suited to handle the connection request by querying the NRF 224. That interface and the N11 interface between the AMF 210 and the SMF 214 assigned by the NRF 224 use the SBI 221. During session establishment or modification, the SMF 214 also interacts with the PCF 212 over the N7 interface and the subscriber profile information stored within the UDM 208. Employing the SBI 221, the PCF 212 provides the foundation of the policy framework which, along with the more typical quality of service (QoS) and charging rules, includes network slice selection, which is regulated by the NSSF 226.

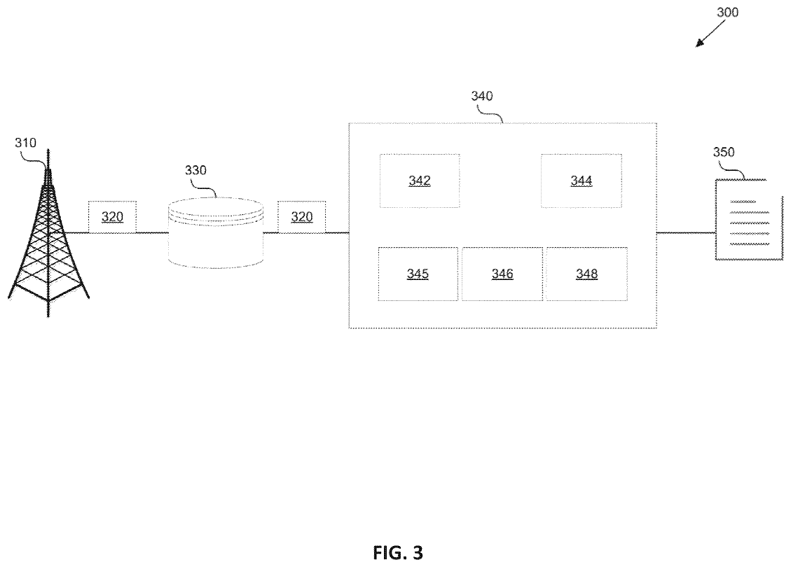

FIG. 3 shows a system 300 to analyze performance of a network 100 in FIG. 1. The current approaches for analyzing performance of the network 100 rely on univariate statistical analysis of each network key performance indicator (KPI) separately. Hence, they are dependent on the type of geographical area (urban, suburban, rural, etc.) under observation, as well as time-of-day/day-of-week data, and they require a lot of expert involvement for careful selection of statistical formulas and associated threshold criteria for analyzing each KPI. KPIs can include drop call rate, uplink (UL) packet loss, throughput, congestion, access failure rate, etc., in a specific geographical area. However, due to the spatiotemporally varying nature of the network 100, these approaches may be inefficient, provide inconsistent results, and require a lot of operational expenditure.

The disclosed system 300 leverages the advances in machine learning (ML) model and multivariate analysis to efficiently and consistently identify trends that have an impact on network 100 performance by jointly analyzing pattern change in all the KPIs, instead of the conventional manual practice of analyzing one KPI at a time using specific statistical formulas.

Performance-related events and trends can then be automatically identified using past KPI values of each cell, instead of the conventional manual practice of using market-specific and cell-specific statistical formulas. The system 300 is large-scale and scalable because the system is market and cell agnostic and can be applied to any cell 310 in any given market or cluster of cells. The system 300 can be applied across multiple radio access network (RAN) vendor platforms across the whole network 100.

The system 300 can obtain KPIs 320 associated with the cell 310 of the network 100 from a performance management database 330 of the network. The module 340 can preprocess the KPI 320 data, described in this application, prior to providing the KPI to ML models 342, 344, 345, 346, 348 that can analyze the KPI data. Once the analysis is complete, the ML models 342, 344, 345, 346, 348 can generate a report 350, which can be stored on a server. In situations where large amounts of storage and compute performance are required, such as market-level or network-level adoption of the system 300 for analyzing thousands or millions of unique cells in parallel, the system 300 can be running on a cloud.

For example, the system 300 can be used to analyze network performance of a 5G or higher generation network 100. Specifically, the module 340 can run as an rApp in an Open RAN of a 5G network. The Open RAN architecture introduces two new types of automation applications, xApps and rApps. RAN automation applications, or rApps, are for automation use cases with more than one-second automation loops. An rApp is designed to run on the non-real-time RIC to realize different RAN automation and management use cases, with control loops on a time scale of one second and longer. The module 340 can complete execution in a matter of minutes or days, and thus can run as an rApp in an Open RAN of a 5G network.

For example, the system 300 can be a web application, running multiple microservices for different detection scenarios. The ML models 342, 344, 345, 346, 348 can be packaged into a container using a container platform such as Docker. The container application then needs to be run in a scalable and reliable manner using a container management system such as Kubernetes.

The ML models 342, 344, 345, 346, 348 can analyze complex real-world systems using multivariate timeseries analysis. Multivariate timeseries analysis seeks to analyze several timeseries (e.g., KPI streams) jointly. Based on the multivariate timeseries analysis, the ML models 342, 344, 345, 346, 348 can detect the possible presence of interdependencies between related KPIs of the same cell 310. These interdependencies, when quantified appropriately, can lead to improved reliability of forecasts, resulting in more robust and accurate detection models. This is due to the fact that in a network 100, the current KPI state is not only dependent on its past states, but also dependent on the state of other related KPIs. However, performance of such a system is highly dependent on the set of KPIs that are grouped together and requires careful selection (for example, selection of KPIs that have higher interdependencies and correlation). The ML models 342, 344, 345, 346, 348 can detect interdependencies and correlations between the KPIs 320.

Further, ML models 342, 344, 345, 346, 348 can detect and classify problems better than classical methods, due to ML models' ability to support noisy features and noise in the relationships between KPI streams, to handle irrelevant features, and to support complex relationships between different KPIs. The ML models 342, 344, 345, 346, 348 can therefore scale to a large-scale network, because each cell 310 can have its own ML model that is jointly analyzing a set of relevant KPIs 320 and is updated regularly with the incoming performance data.

The ML model 342 can perform multivariate timeseries outlier detection. The ML model 342 can detect an anomaly, such as an abnormal spike/event, in one or more timeseries in a multivariate timeseries data, e.g., KPI 320. The abnormal spike/event can be a step function change to a value of a KPI 320. The ML model 342 can automatically capture and identify sudden degradation in performance within 24 hours of occurrence, using past values of KPI 320 for a given cell 310 or cluster of cells. The ML model 342 can apply multivariate timeseries outlier detection algorithms to automatically detect anomalies by jointly analyzing pattern changes in all KPIs 320.

For example, the ML model 342 can detect whether there is a hardware outage associated with the cell 310. If there is a hardware outage, the KPI 320 can include a large drop in throughput KPI, or a large increase in call drop rate KPI. The large increase can be the step function. Once detected, the ML model 342 can produce the report 350 indicating that there is a performance issue with the cell 310 and the time when the performance issue occurred, for example, the time when the step function appeared in the KPI 320.

The ML model 344 can perform multivariate timeseries change point detection. The ML model 344 can identify times when the probability distribution of one or more timeseries changes, e.g., the change of mean in a multivariate timeseries. The ML model 344 can identify an event that occurred in the past and caused a change in cell performance trend, using past values of KPI 320 for a given cell 310 or cluster of cells. The ML model 344 can apply multivariate timeseries change point detection algorithms to automatically detect change points by jointly analyzing pattern changes in all KPIs 320.

For example, an event that happened in the past can cause the number of UEs to increase in the cell 310, and the throughput per UE to fall. The event can be a failure of a neighboring cell tower, an opening of an office building that is served by the cell 310, etc. The ML model 344 can aid in identifying the time at which the event occurred, such as Jul. 4, 2022. Based on the time at which the event occurred, the ML model 344 can aid in identifying the event, by analyzing all the network events that happened at the particular time.

The ML model 345 can perform multivariate timeseries trend detection. While change point detection performed by the ML model 344 detects a particular change point, such as July 4, the ML model 345 can perform trend detection which includes changes occurring over a longer period of time, such as several days weeks or months. The ML model 345 can identify significant and prolonged changes in one or more timeseries in a multivariate timeseries. Rather than identifying change points, trend detection identifies windows of gradual and prolonged change.

The ML model 345 can identify gradual performance trend change that caused a progressive degradation in performance over a given timeframe, e.g., 30 days, using past values of indicator metrics for a given cell or cluster of cells. The ML model 345 can apply multivariate timeseries trend detection algorithms for identifying gradual trend changes, by jointly analyzing pattern changes in all key performance indicators.

The ML model 346 can perform multivariate timeseries classification. The ML model 346 can distinguish between different types/classes of events in one or more timeseries in a multivariate timeseries data. Multivariate timeseries classification can be used to identify KPIs 320 relevant to a performance goal associated with the network 100. For example, if the performance goal associated with the network 100 is to increase the throughput, the ML model 346 can identify the KPIs relevant to throughput by, for example, identifying average user throughput per UE, average cell throughput per UE on uplink and downlink, maximum throughput per cell on uplink and downlink, subchannel layer throughput on uplink and downlink, etc.

The ML model 348 can perform multivariate timeseries forecasting. The ML model 348 can predict future state/trend of one or more timeseries in a multivariate timeseries data.

The ML model 348 can forecast when the cell 310 will have reached or exceeded its capacity to serve the users and services seeking to connect to it, using past values of indicator metrics. The ML model 348 can apply multivariate timeseries forecasting algorithms for forecasting the cell load/capacity, by jointly analyzing pattern changes in the capacity-related key performance indicators. While the present disclosure has been described herein in connection with certain embodiments so that aspects thereof may be more fully understood and appreciated, it is not intended that the present disclosure be limited to these particular embodiments. On the contrary, it is intended that all alternatives, modifications and equivalents are included within the scope of the present disclosure as defined herein. Thus the examples described above, which include particular embodiments, will serve to illustrate the practice of the inventive concepts of the present disclosure, it being understood that the particulars shown are by way of example and for purposes of illustrative discussion of particular embodiments only and are presented in the cause of providing what is believed to be the most useful and readily understood description of procedures as well as of the principles and conceptual aspects of the present disclosure. Changes may be made in the devices, components and methods described herein, and in the steps or the sequence of steps of the methods described herein without departing from the spirit and scope of the present disclosure. Further, while various embodiments of the present disclosure have been described in claims herein below, it is not intended that the present disclosure be limited to these particular claims. Applicants reserve the right to amend, add to, or replace the claims indicated herein below in subsequent patent applications.

In step 340, the processor can train multiple ML models to identify the performance issue associated with the wireless telecommunication network by adjusting multiple hyperparameters associated with the multiple ML models, where the multiple hyperparameters include a window size, a trend change, or trend direction. The multiple machine learning models can be executed as rApps in an Open RAN associated with a 5G or higher generation of wireless telecommunication network. A first ML model among the multiple ML models can be configured to identify a sudden performance degradation. A second ML model among the multiple ML models can be configured to identify an event leading to an abrupt change, such as a change occurring within 24 hours, in a performance trend. A third ML model among the multiple ML models can be configured to identify a gradual change in the performance trend. A fourth ML model among the multiple ML models can be configured to identify whether the cell of the wireless telecommunication network is nearing a capacity limitation associated with the cell.

In step 350, the processor can provide a report based on the identified performance issue. In addition, the processor can train individual models described in this application, and perform additional steps described in this application.

FIG. 4A is a block diagram that illustrates an example of a user equipment 400 in which at least some operations described herein can be implemented. Where appropriate, one or more user equipment 400 can perform operations in real time, near real time, or in batch mode. The embodiment of user equipment 400 shown in FIG. 4A is for illustration only, and wireless devices 104 of FIG. 1 can have the same or similar configuration. However, a user equipment 400 has various configurations, and FIG. 4A does not limit the scope of the present disclosure to any specific implementation of the user equipment 400.

The user equipment (UE) 400 includes a UE antenna 405, a UE radio frequency (RF) transceiver 410, a UE transmission (TX) processing circuit 415, a microphone 420, and a UE reception (RX) processing circuit 425. The user equipment 400 also includes a speaker 430, a UE processor/controller 440, a UE input/output (I/O) interface 445, a UE input device(s) 450, a UE display 455, and a UE non-transitory memory 460. The UE non-transitory memory 460 may store a UE operating system (OS) 461 and one or more applications 462.

The UE RF transceiver 410 receives an incoming RF signal transmitted by a base station 102 of the network 100 from the UE antenna 405. The UE RF transceiver 410 down-converts the incoming RF signal to generate an intermediate frequency (IF) or baseband signal. The IF or baseband signal is transmitted to the UE RX processing circuit 425, where the UE RX processing circuit 425 generates a processed baseband signal by filtering, decoding and/or digitizing the baseband or IF signal. The UE RX processing circuit 425 transmits the processed baseband signal to speaker 430 (such as for voice data) or to UE processor/controller 440 for further processing (such as for web browsing data).

The UE TX processing circuit 415 receives analog or digital voice data from microphone 420 or other outgoing baseband data (such as network data, email or interactive video game data) from UE processor/controller 440. The UE TX processing circuit 415 encodes, multiplexes, and/or digitizes the outgoing baseband data to generate a processed baseband or IF signal. The UE RF transceiver 410 receives the outgoing processed baseband or IF signal from the UE TX processing circuit 415 and up-converts the baseband or IF signal into an RF signal transmitted via the UE antenna 405.

The UE processor/controller 440 can include one or more processors or other processing devices and execute an OS 461 stored in the UE non-transitory memory 460 in order to control the overall operation of user equipment 400. For example, the UE processor/controller 440 can control the reception of forward channel signals and the transmission of backward channel signals through the UE RF transceiver 410, the UE RX processing circuit 425 and the UE TX processing circuit 415 according to well-known principles. In some embodiments, the UE processor/controller 440 includes at least one microprocessor or microcontroller.

The UE processor/controller 440 is also capable of executing other processes and programs residing in the UE non-transitory memory 460, such as processes for receiving system information and information corresponding to different classes for handover signaling; transmitting a capability information including information indicating support of enhanced signaling mechanisms; receiving configuration information including measurement information and handover information based on the capability information; determining completion of handover based on the configuration information; and transmitting a completion of handover indication using a non-Radio Resource Control mechanism based on the completion of handover determination. The UE processor/controller 440 can move data into or out of the UE non-transitory memory 460 as required by an execution process. In some embodiments, the UE processor/controller 440 is configured to execute an application 462 based on the OS 461 or in response to signals received from the base station 102 or the operator. The processor/controller 440 is also coupled to a UE I/O interface 445, where the UE I/O interface 445 provides a user equipment 400 with the ability to connect to other devices such as laptop computers and handheld computers. UE I/O interface 445 is operable to form a communication path between these accessories and the processor/controller 440. For example, the UE I/O interface 445 may be constructed in accordance with the requirements of communication protocols known in the art, such as NFC or Bluetooth.

The UE processor/controller 440 is also coupled to the input device(s) 450 and the display 455. An operator of a user equipment 400 can input data into the user equipment 400 using the UE input device(s) 450. The UE display 455 may be a liquid crystal display or other display capable of presenting text and/or at least limited graphics (such as from a website). The UE non-transitory memory 460 is coupled to the UE processor/controller 440. In some implementations, a part of the UE non-transitory memory 460 can include a random access memory (RAM), while another part of the UE non-transitory memory 460 can include a flash memory or other read-only memory (ROM).

Although FIG. 4A illustrates an example of user equipment 400, various changes can be made to FIG. 4A. For example, various components in FIG. 4A can be combined, further subdivided or omitted, and additional components can be added according to specific requirements. As a specific example, the UE processor/controller 440 can be divided into a plurality of processors, such as one or more central processing units (CPUs) and one or more graphics processing units (GPUs). Furthermore, although FIG. 4A illustrates that the user equipment 400 is configured as a mobile phone or a smart phone, UEs 400 can be configured to operate as other types of mobile or fixed devices. In some implementations, user equipment 400 may be a wireless device 104 in the form of a mobile telephone, but can alternatively take any physical form and share a similar architecture as that of a server computer, personal computer (PC), tablet computer, game console, music player, wearable electronic device, network-connected (“smart”) device (e.g., a television or home assistant device), ARNR systems (e.g., head-mounted display), or any electronic device capable of executing a set of instructions that specify action(s) to be taken by the user equipment 400. In some implementations, the user equipment 400 can be an embedded computer system, a system-on-chip (SOC), a single-board computer system (SBC), or be part of a distributed system such as a mesh of computer systems, or the user equipment 400 can include one or more cloud components in one or more networks.

FIG. 4B illustrates an example base station 102 according to the present disclosure. The embodiment of base station 102 shown in FIG. 4B is for illustration only, and other base stations 102 of FIG. 1 can have the same or similar configuration. However, a base station 102 has various configurations, and FIG. 4B does not limit the scope of the present disclosure to any specific implementation of the base station 102. It should be noted any base station 102a . . . 102n can include the same or similar structures as base station 102 depicted in FIG. 4B.

As shown in FIG. 4B, base station (BS) 102 includes a plurality of BS antennas 470a . . . 470n, a plurality of BS RF transceivers 472a . . . 472n, a BS transmission (TX) processing circuit 474, and a BS reception (RX) processing circuit 476. In certain embodiments, one or more of the plurality of BS antennas 470a . . . 470n include a 2D antenna array. Base station 102 also includes a BS controller/processor 478, a BS non-transitory memory 480, and a BS backhaul or network interface 482.

BS RF transceivers 472a . . . 472n receive an incoming RF signal from BS antennas 470a . . . 470n, such as a signal transmitted by user equipment 400 or other base stations 102. BS RF transceivers 472a . . . 472n down-convert the incoming RF signal to generate an IF or baseband signal. The IF or baseband signal is transmitted to the BS RX processing circuit 476, where the BS RX processing circuit 476 generates a processed baseband signal by filtering, decoding and/or digitizing the baseband or IF signal. BS RX processing circuit 476 transmits the processed baseband signal to BS controller/processor 478 for further processing.

The BS TX processing circuit 474 receives analog or digital data (such as voice data, network data, email or interactive video game data) from the BS controller/processor 478. BS TX processing circuit 474 encodes, multiplexes and/or digitizes outgoing baseband data to generate a processed baseband or IF signal. BS RF transceivers 472a . . . 472n receive the outgoing processed baseband or IF signal from BS TX processing circuit 474 and up-convert the baseband or IF signal into an RF signal transmitted via BS antennas 470a . . . 470n.

The BS controller/processor 478 can include one or more processors or other processing devices that control the overall operation of base station 102. For example, the BS controller/processor 478 can control the reception of forward channel signals and the transmission of backward channel signals through the BS RF transceivers 472a . . . 472n, the BS RX processing circuit 476 and the BS TX processing circuit 474 according to well-known principles. The BS controller/processor 478 can also support additional functions, such as higher-level wireless communication functions. For example, the BS controller/processor 478 can perform a Blind Interference Sensing (BIS) process such as that performed through a BIS algorithm, and decode a received signal from which an interference signal is subtracted. A BS controller/processor 478 may support any of a variety of other functions in base station 102. In some embodiments, the controller/processor 478 includes at least one microprocessor or microcontroller.

The BS controller/processor 478 is also capable of executing programs and other processes residing in a BS non-transitory memory 480, such as a basic OS. By example, the BS controller/processor 478 can perform a variety of operations to initiate, execute, and complete handover operations and calculate one or more parameters to offset a measured signal strength of the user equipment 400.

The BS controller/processor 478 is also coupled to the BS backhaul or network interface 482. The BS backhaul or network interface 482 allows base station 102 to communicate with other devices or systems through a backhaul connection or through a network. The BS backhaul or network interface 482 can support communication over any suitable wired or wireless connection(s). For example, when base station 102 is implemented as a part of a cellular communication system, such as a cellular communication system supporting 5G or new radio access technology or NR, LTE or LTE-A, the BS backhaul or network interface 482 can allow base station 102 to communicate with other base stations 102 through wired or wireless backhaul connections. When base station 102 is implemented as an access point, the BS backhaul or network interface 482 can allow base station 102 to communicate with a larger network, such as the Internet, through a wired or wireless local area network or through a wired or wireless connection. The BS backhaul or network interface 482 includes any suitable structure that supports communication through a wired or wireless connection, such as an Ethernet or an RF transceiver.

The BS non-transitory memory 480 is coupled to the BS controller/processor 478. A part of the BS non-transitory memory 480 can include an RAM, while another part of the BS non-transitory memory 480 can include a flash memory or other ROMs. In certain embodiments, a plurality of instructions, such as instructions for calculating and implementing a UIO in accordance with the present disclosure, are stored in the BS non-transitory memory 480.

Although FIG. 4B illustrates an example of a base station 102, various changes may be made to FIG. 4B. For example, base station 102 can include any number of each component shown in FIG. 4A or FIG. 4B. As a specific example, the access point can include many BS backhaul or network interfaces 482, and the BS controller/processor 478 can support routing functions to route data between different network addresses. As another specific example, although shown as including a single instance of the BS TX processing circuit 474 and a single instance of the BS RX processing circuit 476, base station 102 can include multiple instances of each (such as one for each RF transceiver).

Frequently, user equipment 400 is not spatially static within network 100. This can occur due to a user carrying user equipment 400 throughout network 100 such as by walking or by vehicular travel. This results in user equipment 400 frequently moving in and out of a coverage area 112a of a base station 102a, and into a neighboring coverage area 112b of a neighboring base station 102b. To maintain a connection of the user equipment 400 with the network 100, the network 100 must “handover” the connection to user equipment 400 from the first base station 102a to the second base station 102b, for example.

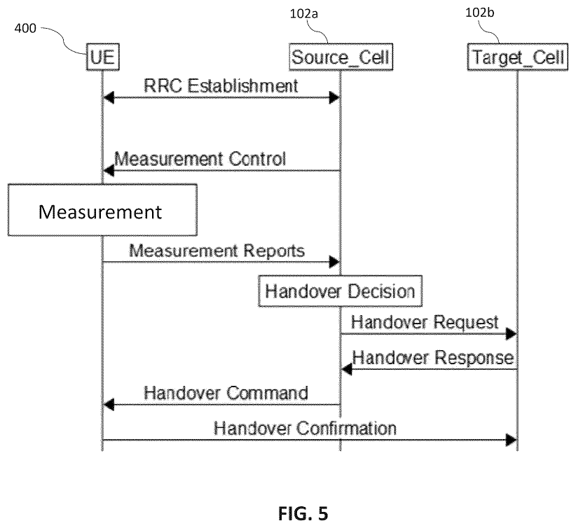

A contemporary 3GPP handover mechanism is illustrated between the user equipment 400, serving base station 102a, and target base station 102b in FIG. 5. For simplicity, the term “target base station 102b” as used herein may encompass some or all of the logic and/or hardware of intervening core network and associated control planes, such as an Access Management Function (AMF) in 5G networks 100 and Mobility Management Entity in 4G networks 100. Requests transmitted to and from target base station 102b may therefore be directly to/from the physical target base station 102b or any aspect of the core network.

First, a Radio Resource Control (RRC) connection is formed between the user equipment 400 and the serving base station 102a. An RRC connection request is transmitted from the user equipment 400 to the serving base station 102a. To send the RRC connection request, the UE processor/controller 440 executes instructions stored in the UE non-transitory memory 460 to generate an RRC Connection Request. This request is converted to an RF signal by the UE TX processing circuit 415 and the UE RF transceiver 410, then transmitted via the UE antenna 405. The serving base station 102a BS antennas 470a . . . 470n receive the RF signal, and the RF transceivers 472a . . . 472n and the BS RX processing circuit 476 down-convert and process the signal. The BS controller/processor 478 executes instructions from the BS non-transitory memory 480 to generate an RRC Connection Setup response. The response is converted into an RF signal by the BS TX processing circuit 474 and the BS RF transceivers 472a . . . 472n, and transmitted via the BS antennas 470a . . . 470n. The user equipment 400 then completes the RRC connection process by transmitting an RRC connection complete message using its respective RF components.

Next, a measurement report may be generated and transmitted to the serving base station 102a to evaluate a signal strength of the serving base station 102a and the target base station 102b with the user equipment 400. First, the BS controller/processor 478 generates a Measurement Control message, which configures the user equipment 400 to perform certain measurements on the serving base station 102a and target base station(s) 102b. This message carries configuration information regarding the measurements to be taken by the user equipment 400, such as which cells to monitor, what signal strength and quality metrics to measure (e.g., Reference Signal Received Power (RSRP), Reference Signal Received Quality (RSRQ)), and how frequently to perform these measurements. This message may also contain offset parameters such as the cell individual offset (CIO) to modify a measured signal strength by the user equipment 400. This message is transmitted to the user equipment 400 via the BS TX processing circuit 474, BS RF transceivers 472a . . . 472n, and BS antennas 470a . . . 470n. The UE RF transceiver 410 and UE RX processing circuit 425 receive and process the message. The UE processor/controller 440 stores the measurement configuration in the UE non-transitory memory 460.

Following the Measurement Control message, the user equipment 400 actively performs the specified measurements. The UE RF transceiver 410 and UE RX processing circuit 425 periodically scan and measure the signal strength and quality metrics from the serving and neighboring cells. The UE RF transceiver 410 and UE RX processing circuit 425 receives Resource Elements (REs) from the serving base station 102a and the target base station(s) 102b carrying the Reference Signal (RS), and the UE processor/controller 440 averages these measurements to obtain an RSRP. For intra-frequency measurements, the UE RF transceiver 410 measures the signal strength from the target base station(s) 102b by tuning to the same frequency of the target base station(s) 102b during measurement gaps (brief pauses in transmission/reception) and recording the measurements. The UE processor/controller 440 processes and stores these measurements in the UE non-transitory memory 460. Then, the UE processor/controller 440 generates a Measurement Report. This report is transmitted to the base station via the UE TX processing circuit 415, UE RF transceiver 410, and UE antenna 405. In some implementations, the Measurement Report is generated by the user equipment 400 periodically. In other implementations, the Measurement Report may be event-triggered when the UE processor/controller 440 evaluates that certain criteria have been met. An example of one such event condition is in eq. (4) below.

Next, the BS controller/processor 478 receives and evaluates the Measurement Report and determines whether the adjusted signal strength and quality measurement exceeds a handover threshold, which is a predetermined handover event trigger based upon an evaluation of the Measurement Report. In some implementations, exceeding a handover threshold may mean that a signal strength of the target base station 102b is greater than the adjusted signal strength and quality measurement of the serving base station 102a. Then, the BS controller/processor 478 generates a Handover Request. This request may be transmitted to the target base station 102b via the BS backhaul or network interface 482, or converted into an RF signal by the BS TX processing circuit 474 and the BS RF transceivers 472a . . . 472n, and transmitted via the BS antennas 470a . . . 470n. The target base station 102b may receive the Handover Request and the BS controller/processor 478 of the target base station 102b generates a Handover Response, which is sent back to the source base station via its backhaul/network interface or converted into an RF signal by the target base station 102b BS TX processing circuit 474 and the BS RF transceivers 472a . . . 472n, and transmitted via the target base station 102b BS antennas 470a . . . 470n to the serving base station 102a.

The serving base station 102a receives the Handover Response indicating either an acceptance or a rejection of the handover. If accepted, the serving base station 102a BS controller/processor 478 generates a Handover Command. This command is transmitted to the user equipment 400 via the BS TX processing circuit 474, BS RF transceivers 472a . . . 472n, and BS antennas 470a . . . 470n. The user equipment 400 receives the command via the respective RF components, and the UE processor/controller 440 initiates a random access channel (RACH) procedure to connect to the target base station 102b.

Due to variability in neighboring base station 102n coverage strength, specific user equipment 400 capabilities and specifications, environmental factors, and user behavior, handover instructions must often be modified by one or more handover offset parameters to ensure smooth and efficient handover without interruption of network 100 coverage.

User individual offset (UIO) is a handover parameter complementary to the currently used cell individual offset (CIO). While CIO lacks flexibility at the user level, UIO is a user specific parameter that may control the handover behavior of each user individually. This enables the selection of UIO values that account for diverse user behavior such as speed, direction, and service requirement. The value of UIO may be represented in dB and can be positive or negative. Prior to initiating a handover event, the measured signal from neighboring base station 102b (e.g., RSRP or RSRQ) is modified by the UIO value. If a positive UIO value is used, the UE processor/controller 440 of the user equipment 400 adds the measured value to the UIO and reports to the base station 102 that the measured signal value is higher than the actual value (i.e., actual value plus UIO). Conversely, if a negative UIO value is used, the UE processor/controller 440 of the user equipment 400 may subtract the UIO from the measured signal value and report that the measured value is lower than the actual value (i.e., actual value minus UIO).

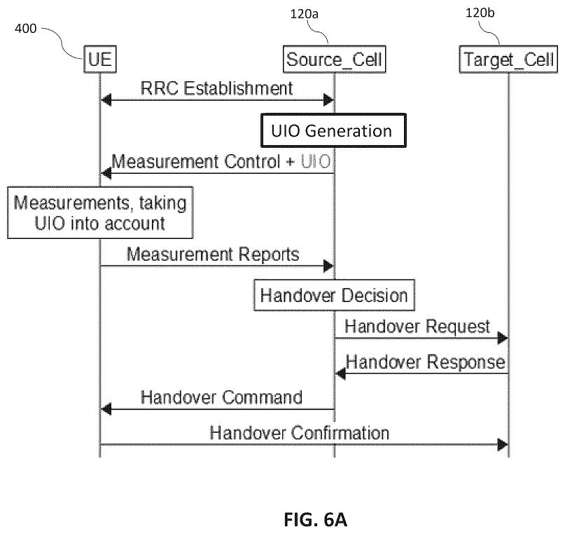

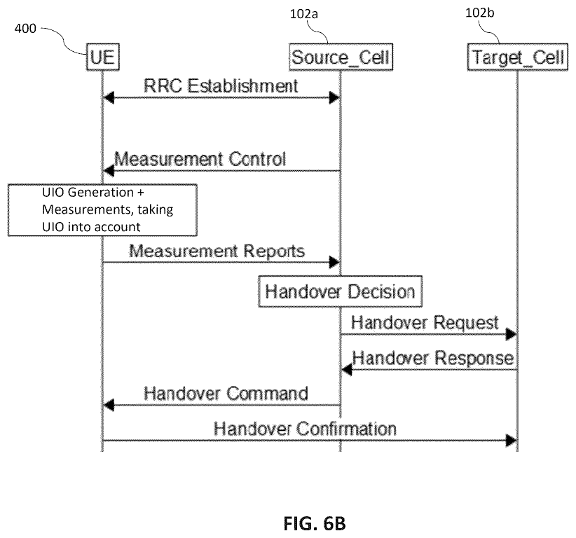

FIGS. 6A and 6B illustrate exemplary handover procedures with UIO implemented. In a first implementation shown in FIG. 6A, a UIO may be generated by the serving base station 102a and transmitted in the Measurement Control message. The Measurement Control message may include instructions to the user equipment 400 to modify one or more signal strength and quality metrics with the UIO. The user equipment 400 may then take measurements of the one or more signal strength and quality metrics, modify the one or more signal strength or quality measurements with the UIO, and transmit the modified signal strength and quality measurements back to the serving base station 102a via the Measurement Reports. The serving base station 102a may then make a Handover Decision based at least partially on the modified signal strength and quality measurements.

To generate a UIO, the BS controller/processor 478 may execute instructions stored in BS non-transitory memory 480. The instructions may be in the form of code executable by the BS controller/processor 478 which may implement any method for generating a UIO taught in this disclosure. In some implementations, the BS controller/processor 478 may retrieve a UE identifier unique to the user equipment 400 from the user equipment 400, from the BS non-transitory memory 480, or from a database via the BS backhaul and network interface 482. The BS controller/processor 478 may then couple the UIO to the UE identifier and store the UIO in the BS non-transitory memory 480 or the database via the BS backhaul and network interface 482.

In some implementations, the BS controller/processor 478 via BS backhaul and network interface 482 may first scan the database for a UIO associated with the UE identifier of user equipment 400. If a UIO is found, the BS controller/processor 478 may retrieve the UIO from the database for transmission to the user equipment 400 via the Measurement Control message. In some implementations, the BS controller/processor 478 may generate a new UIO and store the second or subsequent UIO in the database along with the previous UIO(s), or may overwrite the previous UIO(s) with the new UIO.

In some implementations, the BS controller/processor 478 may retrieve from the user equipment 400 signals corresponding to one or more properties of the user equipment 400. The one or more properties may include location, speed, trajectory, and service requirements of the user equipment 400. The BS controller/processor 478 may calculate the UIO by executing instructions stored in the BS non-transitory memory 480 and accounting for the one or more properties of the user equipment 400. Accounting for the one or more properties of the user equipment 400 can be accomplished in a variety of ways, such as training a machine learning model to map user behaviors determined by historical data obtained by the user equipment 400 on the KPIs of interest.

In some implementations, a plurality of UIO values may be previously calculated according to preset values of the one or more properties of user equipment 400 and stored in the database or in tables stored in BS non-transitory memory 480. The BS controller/processor 478 may then retrieve a UIO from the database or BS non-transitory memory 480 corresponding to values most closely matching the actual one or more properties of user equipment 400 received by the serving base station 102a.

FIG. 6B illustrates a second implementation of a handover procedure according to the present disclosure, whereby the UIO may be generated by the user equipment 400. In such an implementation, the Measurement Control message received by the user equipment 400 from the target base station 102a may authorize the user equipment 400 to independently generate a UIO. In some implementations, the Measurement Control message may specify certain parameters/methods/algorithms for UIO calculation or modification of one or more measured signal parameters with the UIO. The UE processor/controller 440 may execute instructions stored in UE non-transitory memory 460 to calculate a UIO value. The UE processor/controller 440 may then modify one or more signal strength and quality measurements with the UIO, and transmit the one or more modified signal strength and quality measurements to the serving base station 102a in the Measurement Report.

In some implementations, the core network 106 may perform any or all of the functions of the serving base station 102a or target base station 102b. In some implementations, a core network 106 may have an RF transceiver, a processor/controller, and a non-transitory computer readable medium storing computer executable instructions. The non-transitory medium may store computer executable instructions which, when executed by the processor/controller, causes the processor/controller to calculate or retrieve the value of a UIO according to any method provided in this disclosure. The instructions may further cause the processor/controller to transmit, via the RF transceiver, the UIO to at least one base station, which may be the serving base station 102a or a target base station 102b.

To illustrate the impact of UIO on handover, an event A3 is used as a trigger for handover. Event A3 is a mechanism that ensures the user equipment 400 will perform a handover to a neighboring base station 102b with a better signal condition by controlling the mobility decision using an offset parameter. This event is triggered when the neighboring BS signal becomes better than the serving BS signal by an offset value, considering the effect of hysteresis, cell individual offset, and frequency offset. The event report is sent when the following condition remains true for a duration set by the time-to-trigger (TTT) parameter:

$$Mtar + Otar , freq + Otar , cell - hyst > Mserv + Oserv , freq + Oserv , cell + off \qquad Eq . 1$$

wherein the left side of the inequality represents the parameters related to target base stations 102b, 102c, . . . 102n (hereafter “102b”). Mtar represents the measured value of RSRP or RSRQ, Otar, freq denotes the frequency-specific offset, Otar,cell indicates the cell-specific offset, and hyst denotes hysteresis. On the right-hand side, we have the parameters related to the serving base station 102a with the addition of an offset (off) parameter.

It is worth noting that Otar, freq and Oserv, freq are used only when event A3 is configured for inter-frequency handover, whereas they are not used for intra-frequency handover. Inter-frequency handover occurs, as described above, when a serving base station 102a handsover services of user equipment 400 to a target base station 102b at a different frequency. However, in some instances, the serving base station 102a may also perform an intra-frequency handover, where handover occurs from serving base station 102a to target base station 102b at the same frequency.

Considering intra-frequency handover, eq. (1) becomes:

$$M t a r + Otar , cell - hyst > Mserv + O serv , cell + off \qquad Eq . 2$$

By combining the hyst and off parameters into a single parameter called handover margin (HOM), and the Otar,cell and Oserv,cell parameters into a single CIO parameter, eq. (2) can be simplified as follows:

$$M t a r + C I O > Mserv + HOM \qquad Eq . 3$$

When the HOM is fixed to a constant value, it becomes evident that a positive CIO applied from the serving to the target cell facilitates the fulfillment of the event A3 condition, leading to a faster handover trigger from the serving base station 102a to the target base station 102b. Conversely, a negative CIO makes it more challenging to meet the event A3 condition, thereby delaying the triggering of the event and, consequently, the handover.

Eq. (3) represents the current 3GPP standardized event A3 evaluation for handover. All user equipment 400 connected to the serving base station 102a utilize this evaluation criteria. Integration of the novel UIO parameter with the event A3 condition is expressed as follows:

$$Mtar + C IO + IUOx > Mserv + HOM \qquad Eq . 4$$

wherein the subscript x denotes that this new parameter can be customized separately for each user equipment 400. By incorporating this additional parameter, each user equipment 400 can have a distinct handover evaluation condition, providing the network 100 with greater control over the handover behavior of individual user equipment 400.

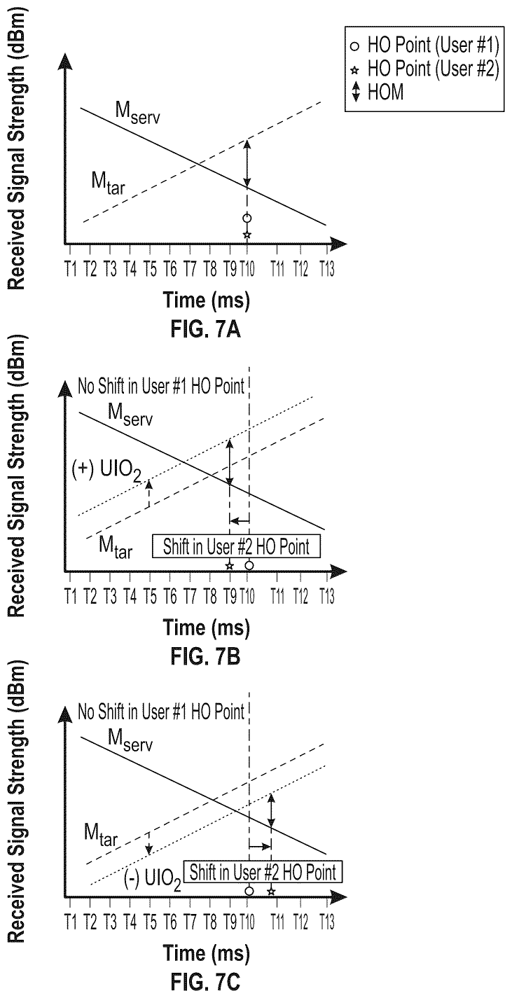

FIGS. 7A, 7B, and 7C illustrate how the implementation of the UIO parameter can alter handover behavior of individual user equipment 400s. Consider two users, user #1 and user #2, both camped on a similar base station 102a, having similar user equipment 400 and traveling at the same speed and direction at the same time. As these users move away from the serving base station 102a and closer to a target base station 102b, the receive signal level (Mserv) of the serving base station 102a decreases while the signal level for the target base station 102b (Mtar) increases. To ensure continuous service for user equipment 400, the source and target base stations 102a and 102b coordinate to aid in handover. When the received signal strength from the target base station 102b exceeds that of the source base station 102a, considering HOM, the serving base station 102a transfers the user equipment 400 to the target base station 102b. FIG. 7A depicts a situation where no UIO is implemented. Without UIO, the handover points for both user equipment 400 occur at a certain time T such as T10. However, UIO can be selectively applied to individual users to modify their handover behavior. In this example, UIO is applied only to the user equipment 400 of user #2, adjusting its handover point without influencing the handover behavior of user #1. With a positive UIO applied to the user equipment 400 of user #2 towards the target base station 102b, as depicted in FIG. 7B, the transition point for UE #2 changes to T9, resulting in an earlier handover. Conversely, as shown in FIG. 7C, when a negative UIO is imposed on the user equipment 400 of user #2 toward the target base station 102b, the handover shifts from T10 to T11, resulting in a later handover.

UIO offers multiple advantages over a CIO-only approach. Firstly, UIO allows the parameter adjustment on individual user behavior, such as user speed, trajectory, serving base station, target base station, and service requirements etc. This individualized nature of the UIO permits the improvement of KPIs 320 for all users, whereas CIO tends to degrade KPIs 320 for some users. Because changing CIO applies to all users, it is challenging to guarantee the overall network and service performance when using or adjusting the CIO. Changing the CIO relationship between neighboring cells could result in heavy traffic on the target cell because all user equipment 400 are affected. By contrast, with UIO, individual user equipment 400 can be specified to perform handovers during load balancing, permitting a greater degree of control over the number of users that can be transferred from one base station 102 to another. UIO further potentially eliminates the conflict between self-organizing network (SON) solutions such as mobility robustness optimization (MRO) and mobility load balancing (MLB) as these SON functions aim at adjusting CIO with opposite values.

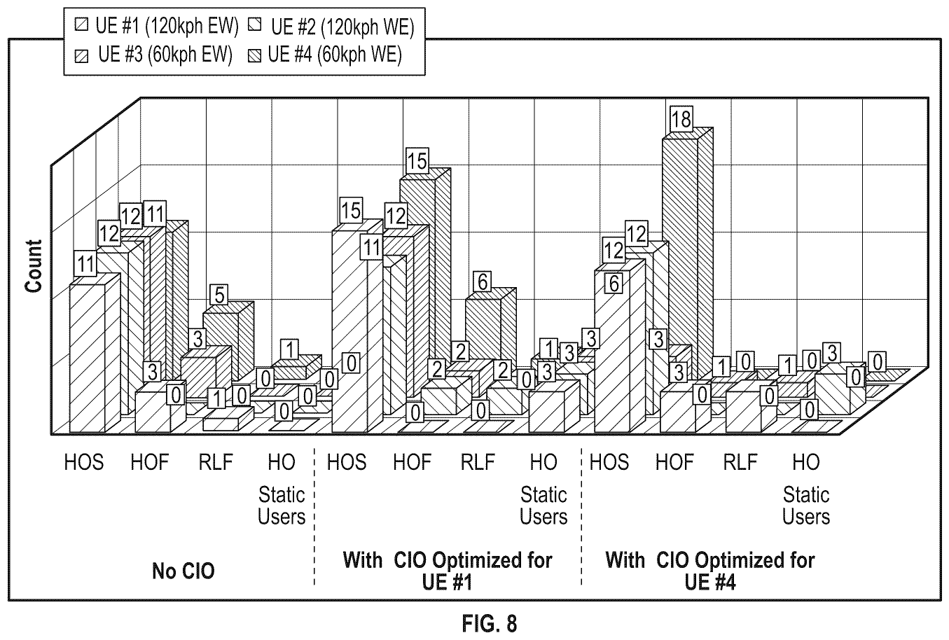

To illustrate the potential detrimental impact of tuning CIO values, an experiment was run to test its impact on static users. A CIO was assigned to generate four network scenarios: a network with default CIO (0 dB is used in all neighbor relations), a network with CIO optimized for user #1, and a network with CIO optimized for user #4. FIG. 8 illustrates the results. Using the default configuration (i.e., no CIO), users #1, #3, and #4 suffer handover issues, including handover failures and radio link failures (RLFs). Then CIO is adjusted such that handover failure and RLF for user #1 is prevented. However, this adjustment to optimize CIO for user #1 results in unwanted handovers for static users. In addition, results indicate a decline in the performance of other mobile users, including handover failure and RLF instances for user #2 that were not existent with the default configuration. Likewise, optimizing CIO to improve the performance of user #4 comes at the expense of unwanted handovers of the static users or performance degradation for other users. These unwanted handovers of static users and adverse impact to other mobile users are unavoidable with a parameter which applies to all user equipment 400 such as CIO. However, this can be avoided with UIO since UIO can target specific user equipment 400 rather than specific base stations 102.

This UIO parameter can be easily adapted to current 5G networks 100, with minimal impact on the existing handover standards. The simplicity of the UIO approach of the present disclosure and compatibility with current standards make the UIO approach of the present disclosure a promising solution for improving handover performance in wireless networks 100.

### UIO Setting and Optimization

The techniques described herein for setting and optimizing a UIO may be implemented by executing with the UE processor/controller 440 or the BS controller/processor 478 computer-readable instructions stored on a non-transitory memory,

One technique for setting and optimizing UIO is a domain knowledge based manual setting. This technique involves identifying the underlying causes of handover issues, such as too early handover, handover to the wrong cell, too late handover, or ping-pong handover. This process requires a high level of domain expertise and practical experience to accurately determine the root cause of the problem. Once the underlying cause has been identified, an appropriate UIO value can be selected to address the issue. For instance, a positive UIO value can be used to address delayed handovers, while negative UIO values can prevent premature handovers by neighboring cells.

Though effective, this technique relies primarily on a hit-and-trial approach to determine the optimal UIO value for each user. Since the UIO values are configured per user, scalability can be challenging given the sheer number of users. Moreover, adjusting the UIO values using this method may only produce a local improvement that is limited to a single user, rather than providing a comprehensive solution that addresses the handover issue across the entire network.

Another technique for setting and optimizing UIO is incorporation into Self-organizing network (SON) solutions such as Mobility Robustness Optimization (MRO). This represents an automated approach to adjusting UIO values based on user feedback. When users report radio link failures caused by different handover issues, such as late or early handover or handover to the wrong cell, the network analyzes the reports either at the Radio Access Network (RAN) or at the core network 106 and determines the optimal UIO for each user using heuristics. While MRO offers a more automated solution than manual UIO adjustment based on domain knowledge, MRO's effectiveness is dependent on the volume of statistical data available. Furthermore, the randomness of the ever-changing transmission environment and user behavior, such as mobility patterns and speed, can limit the effectiveness of UIO adjustments based on feedback. Finally, relying on the MRO approach can make the UIO assignment reactive, which may not be suitable for emerging cellular networks.

A third approach involves artificial intelligence/machine learning (AI/ML) with heuristic optimization (i.e., Genetic algorithm, Simulated Annealing). At a more advanced level, RAN intelligence can observe and learn from a large number of handover events with associated parameters, and use this information to train AI/ML models to identify sets of UIO values that result in successful handovers. This approach offers a more automated and scalable method of UIO setting and optimization. Heuristic algorithms such as genetic algorithm and simulated annealing can be employed to search for the best combinations of the UIO that yield the maximum performance. This approach has the potential to improve handover performance significantly and reduce the need for manual intervention. However, training an AI/ML model with sparse training data can pose challenges to the utility of this approach. The effectiveness of the model depends on the quality and quantity of the training data. Therefore, there is a need for a large and diverse set of handover events and associated parameters to ensure that the AI/ML models are trained effectively. Despite these challenges, the artificial intelligence/machine learning approach holds great promise for the future of cellular networks, as artificial intelligence/machine learning can lead to more efficient and effective handover management.

A fourth approach uses reinforcement learning (RL). The RL model aims to identify the optimal UIO for each user equipment 400, maximizing KPIs 320 like throughput, signal to interference and noise ratio (SINR), handover success rate (HOSR), and load balancing. Using RL for UIO calculation has advantages over data-driven approaches like traditional AI/ML, as RL can learn without massive amounts of data. Instead, it learns iteratively through trial and error, based on the interaction of its agent and environment. By using RL-based UIO, network management and optimization tasks can be automated, leading to improved system performance and a better user experience with minimal human intervention.

A fifth approach implements Graph Neural Network (GNN)-based UIO calculation. Graph Neural Networks (GNNs) are a type of artificial neural network designed to analyze and process complex relationships between entities in graph structured data. By using GNNs in combination with Reinforcement Learning (RL), a hybrid model can be created where GNNs are used to model the state of a graph-structured environment, and RL is used to learn the best actions to take within that environment. For example, a graph could represent the state of a system, with nodes representing the current CIO values, user speed, the current serving base station 102a, and the predicted base station 102b for handover (which is determined by a mobility prediction model). Using this graph, users acting as RL agents can generate the optimal UIO values for the system. This hybrid approach enables the analysis of complex relationships between entities, improving the accuracy and efficiency of decision-making processes.

A sixth approach leverages a digital twin of the cellular network 100. Reinforcement Learning is a trial and error-based learning process, which presents challenges for direct application in a live network due to potential network disruptions. To address this issue, a digital twin (DT) of the cellular network 100 may be used as a training ground for the RL model. A DT is a virtual representation of a physical system that is updated in real-time. Using a DT for RL training improves RL utility, as the actual network 100 is not affected during the training process. While 3GPP Rel. 17 (TR 37.817) recommends AI/ML model training and inference be located at the Operations and Management layer (OAM) or at the base station 102 itself, this approach poses risks, particularly for functions such as handover where the RL model explores different UIO settings. To minimize the impact of the training process on the cellular network 100, a DT may be used to perform the exploration/exploitation task outside of the live network 100. This enables efficient training of the RL model while maintaining network 100 stability.

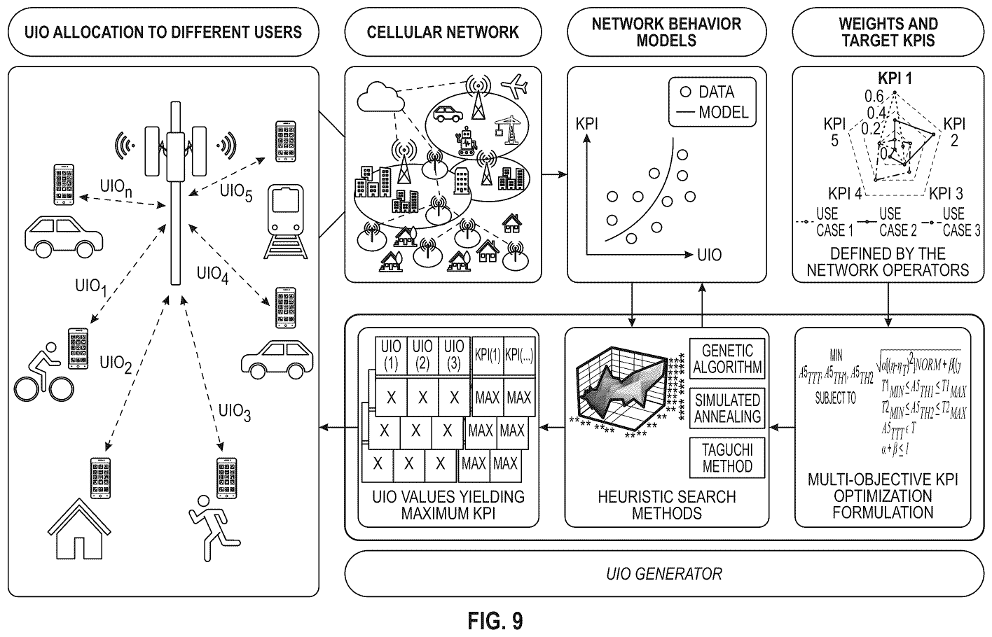

FIG. 9 illustrates an exemplary framework for network-originating UIO according to the third approach, implementing machine learning with heuristic optimization. Firstly, machine learning models are employed to model network 100 behaviors, i.e., the variations in KPIs 320 These models capture the relationship between the Configuration Parameters (COPs) and KPIs, with regression models being a common approach for estimating KPI values based on different sets of UIOs presented in tabular form. Hyperparameter optimization can be performed to achieve optimal model performance.

Once a well-trained machine learning model is obtained, the well-trained machine learning model is combined with an optimization engine to optimize the UIOKPI relationship. Unlike existing SON approaches that rely on a hit-and-trial method, this framework uses the machine learning model to identify the optimal set of COPs that can generate the expected new KPI values. Multi-objective optimization techniques, such as Genetic Algorithm, Taguchi Method, or Simulated Annealing, are employed to estimate the new KPI values for a given set of UIOs. To enhance the customizability of the framework, network operators can assign weights to the KPIs based on their priorities. By assigning higher weights to a particular KPI, the optimization process is prioritized towards that KPI.

Using a heuristic search method, an optimal UIO combination is generated either at the base station(s) 102 or at the core network 106 and relayed to each base station 102. This combination is then allocated to the users using the methods described above. This framework offers a more efficient and effective method for optimizing network performance, while also providing flexibility to accommodate diverse user priorities.

The effectiveness of the UIO in optimizing wireless network performance can be demonstrated through three important KPIs 320: SINR, handover success rate (HOSR), and handover signaling overhead (SigO). By optimizing these KPIs 320, the overall quality of experience (QoE) for wireless network users is enhanced. Specifically, optimizing SINR can enhance the reliability and stability of wireless connections. In addition to indicating the quality of the received signal, SINR also provides an estimate of the network capacity. Meanwhile, maximizing HOSR can minimize the risk of connection dropouts during handovers. Moreover, optimizing HO signaling can reduce the SigO associated with handovers, improving network efficiency and reducing the likelihood of signaling-related errors.

Signal to Interference and Noise Ratio (SINR). For SINR, a ray tracing commercial

planning tool is used to generate an RSRP map [20]. The aster propagation model is deployed for the path loss model, which uses ray tracing propagation techniques to incorporate vertical and horizontal diffraction/reflection. A practical 3-D antenna model is used composed of horizontal and vertical antenna patterns instead of a theoretical antenna pattern equation. The resulting RSRP values from Atoll for user u from the serving base station s at physical resource block (PRB) j is denoted by λ^{u}_{1″s,j}. Using the RSRP values from Atoll, the SINR for a user u on PRB j allocated by base station s, denoted as γ_{s,j}^{u}, can be expressed as follows:

$${γ}_{s , j}^{u} = \frac{{λ}_{s , j}^{u}}{K + {\sum }_{∀ i ∈ {B}_{f}} {λ}_{i , j}^{u}} \qquad Eq . 5$$

where K is the thermal noise, the set Bf contains all the interfering base stations using the same frequency band as the user u and λ^{u}_{i,j} represents the RSRP for user u from an interfering base station i at PRB j.

The SINR for user u connected to base station s can be computed by averaging the SINR γ_{s,j}^{u} for all PRBs allocated to the user. The resulting SINR can be expressed as:

$${γ}_{s}^{u} = \frac{{\sum }_{∀ j ∈ {R}_{u}} {γ}_{s , j}^{u}}{\vert {ℝ}_{u} \vert} \qquad Eq . 6$$

where the set Rᵤ contains all the PRBs allocated to the user u. The mean SINR γ of all the users in the network can be written as:

$$γ = \frac{{\sum }_{∀ i ∈ U} {γ}_{s}^{i}}{\vert U \vert} \qquad Eq . 7$$

where the set U contains all the users in the network.

Handover Success Rate (HOSR). The provision of ultra-reliable low-latency communication (URLLC) is a requirement in the emerging mobile networks, particularly for applications such as intelligent transport systems and autonomous cars. Achieving this objective necessitates the optimization of HOSR, which is a crucial KPI 320 that captures the effectiveness of handover-related parameter settings. A poor HOSR could create a significant bottleneck for URLLC, leading to degraded user experience and potential safety hazards. HOSR & can be expressed as follows:

$$ξ = \frac{HOS}{HOS + HOF} \times 100 \% \qquad Eq . 8$$

where HOS and HOF are the number of successful and failed handovers, respectively, in the network.

Signaling Overhead (SigO). Handovers are an important aspect of cellular networks, but they can also result in added SigO which can impact network performance. Although optimizing KPIs 320 such as the number of HOF, handover latency, and SINR can enhance user quality of experience (QoE), they do not directly represent the burden caused by handovers on the network. To address this, SigO is incorporated as a KPI 320 in the evaluation of handover performance.

To model the overhead of over-the-air signaling messages during handovers, the X2 interface [21] can be used. The X2 interface enables communication between the source and target base station 102 during handovers, and several types of signaling messages are transmitted over this interface. During the handover preparation phase, examples of signaling messages include measurement reports and handover commands (RRC connection reconfiguration). During the HO execution phase, synchronization, uplink allocation, and handover confirmation (RRC connection reconfiguration complete) messages are transmitted. In the event of handover failures, retransmission of these signaling messages can further increase SigO on the network.

To quantify the total handover SigO, the total additional signaling bytes transmitted over-the-air during the handover process may be defined as η. By taking into account both user QoE and SigO, the overall performance of the system can be evaluated and potential areas for optimization can be better identified.

To jointly optimize of mean SINR, HOSR, and SigO, a multi-objective optimization problem may be formulated that minimizes the differences of γ, ξ, and η with the target values of each respective KPI 320. The optimization problem may be mathematically formulated as shown below in Eq. 9.

$${max}_{UIO} ( {α [ γ ]}_{norm} ) + ( {β [ ξ ]}_{norm} ) + {( 1 - α - β ) [ 1 - η ]}_{norm} ; \\ subject to {UIO}_{min} \leq UIO \leq {UIO}_{max} \\ α + β \leq 1 \qquad Eq . 9$$

The operator-defined weights, α and β, can be used to adjust the relative importance of KPIs 320 SINR, HOSR, and SigO. Each KPI 320 is normalized to remove bias towards larger KPI 320 values. This approach ensures that the importance of each KPI 320 is solely defined by their respective weights. The first constraint in Eq. 9 limit the values of the optimization variables (i.e., UIO) to a pre-defined range. The second constraint states that the sum of the three weights is equal to one.

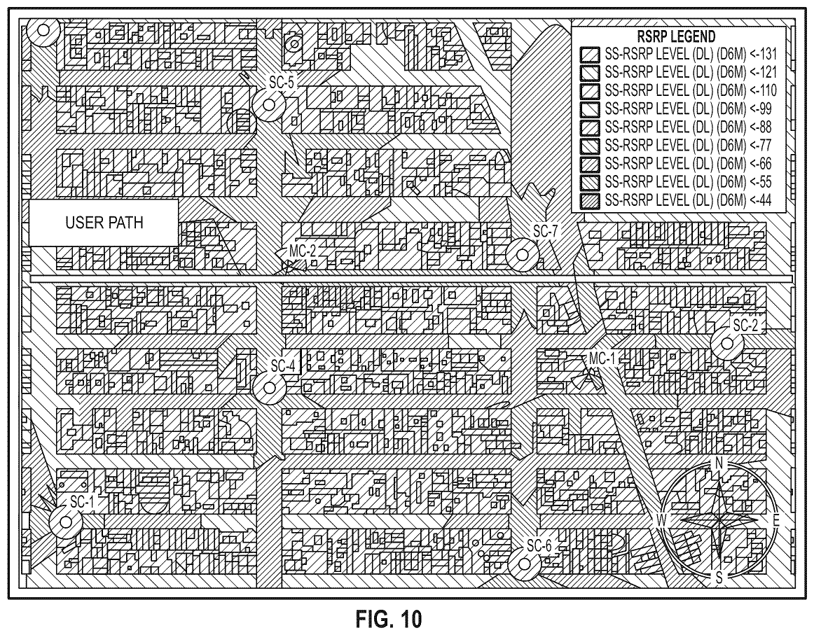

To solve the optimization problem in Eq. 9, a data driven modeling approach may be used as shown in FIG. 10. This simulation includes a network topology of 5G New Radio macro and small cells. To improve the simulation environment's practicality, Digital Terrain Model (DTM) raster files were used that contain the altitude value (in meters) of the ground, as well as features such as rivers and ridges. Clutter classes were used to represent different terrain types, including surface street, open bare ground, grassland, low vegetation, forest, and buildings of various height ranges. Clutter heights maps were used to represent individual heights of clutter. The shadowing effect was incorporated by using a log-normal (Gaussian) distribution, varying the standard deviation according to clutter type.

To conduct mobility simulations, Synthetic NET, a cutting-edge system-level simulator that complies with 3GPP standards [24], was used. Unlike Atoll, SyntheticNET can model 5G mobility parameters in detail. To import realistic network coverage data, Atoll was used and coupled with SyntheticNET. The mobility parameters were initialized based on the GS setting of one of the leading operators in the USA and employed event A3 with an A3-offset of 2 dB, TTT of 128 ms, and hysteresis of 0 dB to trigger the HO process.

During the simulation, we deployed both mobile and static users within the network and ran it until the mobile users completed their path. The mobile users' speeds varied between 30 kph, 60 kph, and 120 kph, and their trajectory was from east (E) to west (W) and vice versa. To simulate network load and investigate the impact of CIO and UIO variations in static users, the simulation deployed 60 static users. Full system parameters are shown below in Table I.

TABLE I
Description of Simulation Parameters

| System parameters | Values | |
|---|---|---|
| Carrier frequency | Small cell: 3.5 GHz | |
| | Macro cell: 800 MHz | |
| Channel bandwidth | Small cell: 50 MHz | |
| | Macro cell: 5 MHz | |
| Maximum transmit power | Small cell: 10 dBm | |
| | Macro cell: 36 dBm | |
| Path loss model | Aster propagation (ray tracing) | |
| Cell sectors | Small: Omni-directional | |
| | Macro: Tri-sectored | |
| Number of sites | Macro: 2 | |
| | Small: 7 | |
| Geographical information | Ground, building heights, land use map | |
| Mobile users speed | 30 km/h, 60 km/h, 102 km/h | |
| Mobile users direction | East to West, West to East | |
| UIO values | [−4, 2, 0, 2, 4] | dB |
| Number of static users | 60 | |
| Bin/grid size | 1 | m |
| Coverage area size | 670000 m² (0.67 km²) | |
| BS height | Small cell: 10 m | |
| | Macro cell: 30 m | |
| Shadowing | Clutter-dependent shadowing | |
| Sampling frequency | 16 | ms |
| Transmission time interval | 1 | ms |
| Total simulation time | 108000 | ms |
| Handover event | Event A3 | |
| A3-offset | 2 | dB |
| A3-TTT | 128 | ms |
| T310 | 1000 | ms |

The simulation cycle begins when the user moves from one end of the simulation area and ends when the mobile user reaches the edge of the area. During each cycle, the users are assigned different combinations of UIO values, which in this study range from [−4, −2, 0, 2, 4] dB. Each user is assigned UIO values based on their neighboring cells. If we follow the current standards, that would allow up to eight neighboring base stations 102n as potential targets for handover when a user is served by one base station 102a. However, assigning eight different UIO values per user per neighboring cell would create an explosion of possible combinations, making data generation too complex. To reduce the complexity, only the base stations 102 that are serving along the tracks of the users were considered. The number of neighboring base stations 102 was also limited to two or three for each base station 102, with the exception of one base station 102 with five close neighbors. For instance, if a user is being served by base station 102 with three neighboring cells, three UIO values were provided for that user, one for each neighbor relation. With this approach, around 18,750 data points are generated consisting of different UIO combinations, user speed, and user direction. These data points are used to train machine learning models and obtain the resulting KPIs.

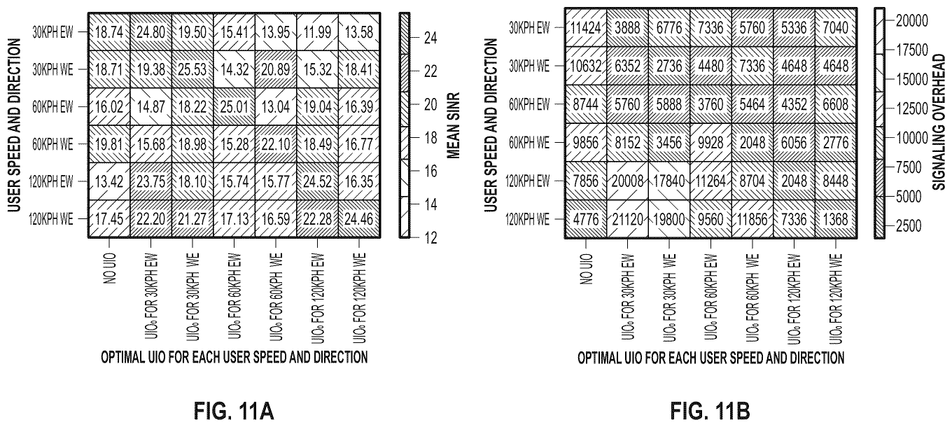

FIG. 11A illustrates the impact of different UIO values on SINR and FIG. 11B illustrates the impact of different UIO values on SigO of different users. The performance of the cases considering no UIO value are compared with the case when UIO is optimized for each user denoted by UIOO. FIGS. 11A and 11B also illustrate the impact if the same value UIOO for a specific user is used for other users, which happens in the case of CIO applied to all users. FIG. 11A shows the variation in mean SINR with different UIO values. It can be observed that the optimal UIO combination for UEs moving at 30 kph from east to west can produce SINR close to 25 dB, which is almost 7 dB higher than the scenario where no UIO is used. However, if this optimal UIO value is employed for other UEs with different speeds or directions, the achievable SINR is lower than the optimal. For instance, the UIO combination that is optimal for a user moving at 30 kph cast to west can only achieve a mean SINR of 15 dB when used for a user moving at 60 kph cast to west, which is even lower than the scenario with no UIO. Nevertheless, the optimal UIO can be tailored for this particular user moving at 60 kph cast to west and the results indicate that this user can also achieve around 25 dB mean SINR. This trend is observed in other users as well, indicating that a UIO combination that is optimal for one user may not be optimal for others. This further highlights the drawback of optimizing CIO, which can only be set to one value per neighbor for all the users of a BS. SINR can be better optimized if the offset is calibrated for each user separately enabled by the UIO proposed in this paper. FIG. 11B shows a similar trend for signaling overhead, where the minimum SigO is achieved when UIO value is optimized for each user separately. The results indicate that UIO offers a level of flexibility that CIO cannot match, as CIO lacks the capability to be uniquely assigned to each user, which in turn prevents the achievement of optimal KPIs 320 for each user.

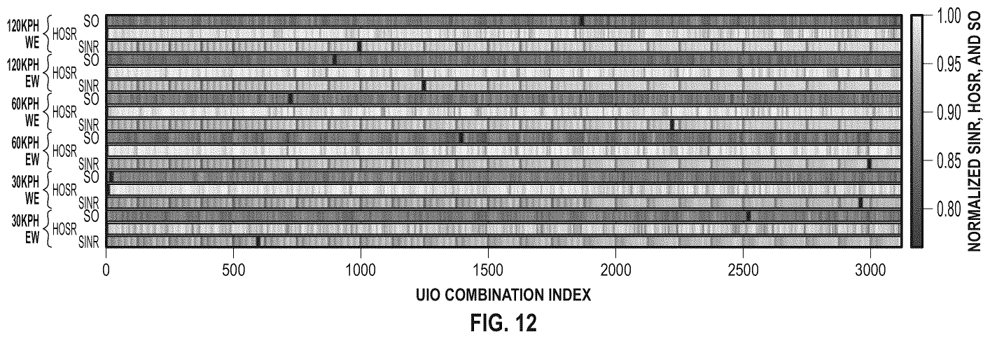

FIG. 12 presents a heat map that showcases all the three KPIs 320 with varying UIO values for users with different speeds and directions. The x-axis represents the index of the UIO combinations based on the generated data. The black line in each row represents the optimal KPI value for each user. It is observed that the optimal black region for each KPI 320 is different even for the same user. This indicates a tradeoff in optimizing the KPIs 320 and hence the need for multi-objective optimization. In addition, the optimal value for each KPI 320 changes with different user speed or direction of movement, which again signifies the importance of optimizing individual offsets for each user.

HOSR exhibits multiple optimal points for different combinations of data. On the other hand, unique COP combinations result in optimal SINR and SigO. For instance, a user moving at 30 kph from east to west can achieve the maximum SINR using UIO combinations with an index of 607, while the maximum SigO can be attained using UIO combinations with an index of 2511. However, for a user with similar speed but moving in the opposite direction, the maximum SINR can be obtained using UIO combinations with an index of 2803, while the optimal SigO can be found using UIO combinations with a UIO combination index of 20. This shows that the user direction in addition to the user speed impacts the optimal UIO combination.

Various machine learning algorithms may be used in predicting KPIs 320 using different combinations of UIO values. As previously discussed, the user speed and direction also impact the best UIO combination that optimizes the KPI 320. Hence, user speed and direction are also provided to the machine learning method along with the UIO combinations. The objective is to compare the performance of leading regression techniques. Tree based algorithms usually have better performance in the mobility management problems [3]. Hence, the performance of decision tree, random forest, XGBoost, and LightGBM is compared to identify the most effective algorithm for predicting the KPIs.

To achieve this goal, an 80%-20% train-test data split was utilized to assess the performance of the algorithms. Table II presents the resulting root mean square error (RMSE) for each algorithm on test data. Our findings indicate that the decision tree algorithm has the poorest performance, with RMSE values of 3.205 dB, 12.2%, and 2195.936 bytes for SINR, HOSR, and SigO, respectively. Among the tree-based algorithms, XGBoost and LightGBM performs the best. More specifically, LightGBM performs best in estimating the mean SINR and HOSR with RMSE of 2.151 dB and 7.8% respectively. Meanwhile, XGboost performs best in predicting the mean SigO with an RMSE of 1580.239 bytes. However, the performance of LightGBM in estimating the SigO is also not far behind XGboost with RMSE of 1591.896 bytes.

TABLE II
Normalized RMSE Comparison of Different Machine Learning
Algorithms for SINR, HOSR, and SigO Prediction.

| | | | Decision | |
|---|---|---|---|---|
| | | | Tree | Random |
| KPI | XGBoost | LightGBM | Regressor | Forest |
| Mean SINR (dB) | 2.238 | 2.151 | 3.205 | 2.423 |
| HOSR (%) | 8.0 | 7.8 | 11.2 | 8.7 |
| Mean SigO (bytes) | 1580.239 | 1591.896 | 2195.936 | 1743.766 |

Results of this study suggest that tree-based algorithms, particularly XGBoost and LightGBM, show promise in accurately predicting KPIs 320, while decision tree algorithms are not well-suited for this task. By utilizing tree-based algorithms like XGBoost and LightGBM, network operators can optimize their networks and improve their overall performance.

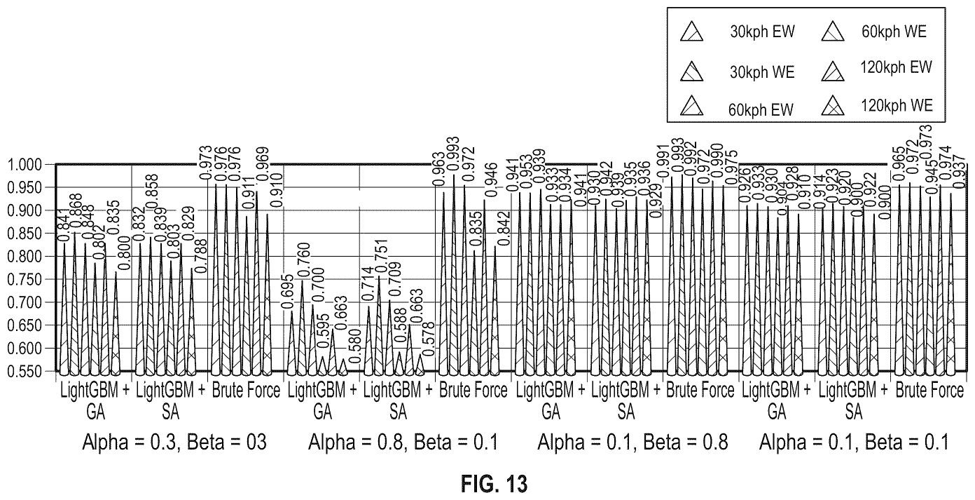

FIG. 13 displays the performance of a proposed machine learning model with heuristics in maximizing the KPIs 320. When α and β are equal to 0.33, indicating equal priority is given to all three KPIs, LightGBM with genetic algorithm (GA) achieves a utility function value between 0.8 to 0.86 for the users. In contrast, LightGBM with simulated annealing (SA) demonstrates a utility function value of approximately 0.78 to 0.85. For comparison, a brute force method of UIO generation was also performed, wherein every possible combination of UIO values were analyzed to determine the UIO values which maximize KPIs. While the brute force generation yields higher utility function values, brute force requires a large number of iterations to determine the optimal values. For instance, in this case, the potential combinations of UIO are approximately 519. This value escalates with the increase in the number of UIO ranges and the number of base stations 102. On the other hand, GA and SA only takes 1000 iterations to converge at near-optimal values.

Furthermore, it can be observed that the difference between the optimal value returned by the heuristic approaches and brute force changes with varying the KPI 320 weights. For example, when α and β re set to 0.1 and 0.8, respectively, indicating a lower priority in optimizing the SINR, the utility function values become comparable to brute force (0.92 or above for all the users). A similar trend is observed when both α and β are set to 0.1 giving a high weight to optimizing SigO. However, it is worth noting that both GA and SA optimization methods exhibit a decrease in performance when more weight is given to α, indicating higher priority to SINR. This is due to the more unpredictable nature of SINR, which ML models may fail to capture as accurately as handover success rate and SigO. The highest difference between the brute force and both SA and GA is observed when α and β are set to 0.8 and 0.1, respectively. This strengthens the point that SINR is a difficult KPI 320 to accurately capture for ML models.

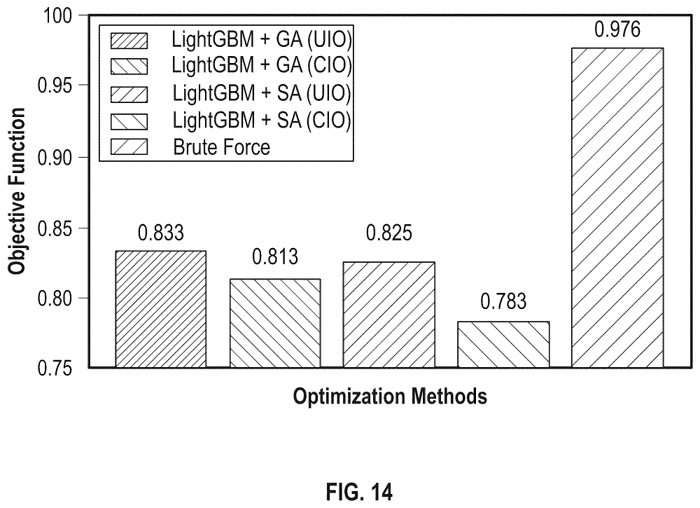

To compare the performance of UIO with CIO, an experiment was conducted where the CIO values were varied and the corresponding data was generated. FIG. 14 shows the results. The results indicate that the objective function value is higher when using UIO as the parameter instead of CIO. This trend is observed for both GA and SA. By combining LightGBM with GA, we were able to achieve an objective function of 0.833 with UIO optimization, whereas the use of CIO only yielded a maximum of 0.813. The difference in performance is even more pronounced when SA is utilized. Specifically, UIO-optimized networks display an objective function value of 0.825, whereas networks optimized using CIO exhibit a lower objective function value of 0.783. This indicates the superior performance of UIO compared to CIO.

### Conclusion

Conventionally, cellular network administrators have used configuration parameters such as cell individual offset (CIO) to mitigate handover failures and improve user quality of experience. However, while CIO can improve the quality of experience for some users, this often comes with a reduced qualify of experience for other users. The user individual offset (UIO) proposed in the present disclosure allows for optimization at the individual user level with the goal of improving the quality of experience for all users. Using UIO, multiple key performance indicators can be optimized for individual users with improved performance over CIO-only methods.

The foregoing description provides illustration and description, but is not intended to be exhaustive or to limit the inventive concepts to the precise form disclosed. Modifications and variations are possible in light of the above teachings or may be acquired from practice of the methodologies set forth in the present disclosure.

Even though particular combinations of features are recited in the claims and/or disclosed in the specification, these combinations are not intended to limit the disclosure. In fact, many of these features may be combined in ways not specifically recited in the claims and/or disclosed in the specification. Although each dependent claim listed below may directly depend on only one other claim, the disclosure includes each dependent claim in combination with every other claim in the claim set.

No element, act, or instruction used in the present application should be construed as critical or essential to the invention unless explicitly described as such outside of the preferred embodiment. Further, the phrase “based on” is intended to mean “based, at least in part, on” unless explicitly stated otherwise.

### REFERENCES

[1] Imran, A. Zoha, and A. Abu-Dayya, “Challenges in 5G: how to empower SON with big data for enabling 5G,” IEEE Network, vol. 28, pp. 27-33, November 2014.
[2] M. Manalastas, M. U. B. Farooq, S. M. A. Zaidi, A. Abu-Dayya, and A. Imran, “A data-driven framework for inter-frequency handover failure prediction and mitigation,” IEEE Transactions on Vehicular Technology, vol. 71, no. 6, pp. 6158-6172, 2022.
[3] M. Umar Bin Farooq, M. Manalastas, W. Raza, S. M. A. Zaidi, A. Rizwan, A. Abu-Dayya, and A. Imran, “A data-driven self optimization solution for inter-frequency mobility parameters in emerging networks,” IEEE Transactions on Cognitive Communications and Networking, vol. 8, no. 2, pp. 570-583, 2022.
[4] J. Joseph, F. Ahmed, T. Jokela, O. Tirkkonen, J. Poutanen, and J. Niemela, “Big data enabled mobility robustness optimization for commercial lte networks,” in 2020 IEEE Wireless Communications and Networking Conference (WCNC), pp. 1-6, 2020.
[5] J. Shodamola, U. Masood, M. Manalastas, and A. Imran, “A machine learning based framework for kpi maximization in emerging networks using mobility parameters,” in 2020 IEEE International Black Sea Conference on Communications and Networking (BlackSeaCom), pp. 1-6, 2020.
[6] M. Z. Asghari, M. Ozturk, and J. Ham [symbol] al [symbol] ainen, “Reinforcement learning” based mobility load balancing with the cell individual offset,” in 2021 IEEE 93rd Vehicular Technology Conference (VTC2021-Spring), pp. 1-5, 2021.
[7] A. Madelkhanova, Z. Becvar, and T. Spyropoulos, “Optimization of cell individual offset for handover of flying base stations and users,” IEEE Transactions on Wireless Communications, pp. 1-1, 2022.
[8] G. Alsuhli, H. A. Ismail, K. Alansary, M. Rumman, M. Mohamed, and K. G. Seddik, “Deep reinforcement learning-based cio and energy control for lte mobility load balancing,” in 2021 IEEE 18th Annual Consumer Communications Networking Conference (CCNC), pp. 1-6, 2021.
[9] S. Chang, G. Li, J. Zhao, J. Wu, and B. Zhang, “Individualized optimization of handover parameters in 5 g (nr) indoor and outdoor co-frequency scenarios,” in 2021 IEEE International Conference on Consumer Electronics and Computer Engineering (ICCECE), pp. 59-66, 2021.
[10] T. Goyal and S. Kaushal, “Handover optimization scheme for lte advance networks based on ahp-topsis and q-learning,” Computer Communications, vol. 133, pp. 67-76, 2019.
[11] D. Castro-Hernandez and R. Paranjape, “Optimization of handover parameters for lte/lte-a in-building systems,” IEEE Transactions on Vehicular Technology, vol. 67, no. 6, pp. 5260-5273, 2018.
[12] M. M. Hasan, S. Kwon, and S. Oh, “Frequent-handover mitigation in ultra-dense heterogeneous networks,” IEEE Transactions on Vehicular Technology, vol. 68, no. 1, pp. 1035-1040, 2019.
[13] K. Da Costa Silva, Z. Becvar, and C. R. L. Frances, “Adaptive hysteresis margin based on fuzzy logic for handover in mobile networks with dense small cells,” IEEE Access, vol. 6, pp. 17178-17189, 2018.
[14] T. A. Achhab, F. Abboud, and A. Assalem, “A robust self-optimization algorithm based on idiosyncratic adaptation of handover parameters for mobility management in lte-a heterogeneous networks,” IEEE Access, vol. 9, pp. 154237-154264, 2021.
[15] A. Alhammadi, M. Roslee, M. Y. Alias, I. Shayea, S. Alraih, and K. S. Mohamed, “Auto tuning self-optimization algorithm for mobility management in lte-a and 5 g hetnets,” IEEE Access, vol. 8, pp. 294-304, 2020.
[16] R. Karmakar, G. Kaddoum, and S. Chattopadhyay, “Mobility management in 5 g and beyond: A novel smart handover with adaptive time-to-trigger and hysteresis margin,” IEEE Transactions on Mobile Computing, vol. PP, pp. 1-16, 01 2022.
[17] I. Shayea, M. Ergen, A. Azizan, M. Ismail, and Y. I. Daradkeh, “Individualistic dynamic handover parameter self-optimization algorithm for 5 g networks based on automatic weight function,” IEEE Access, vol. 8, pp. 214392-214412, 2020.
[18] “3gpp ts 36.331: “evolved universal terrestrial radio access (e-utra); radio resource control (rrc) protocol specification”.”
[19] “3gpp ts 37.817: “study on enhancement for data collection for nr and endc”.”
[20] “Atoll.” [Online]. https://www.forsk.com/. Accessed: 26 Mar. 2023.
[21] Y. Ren, J.-C. Chen, and J.-C. Chin, “Impacts of S1 and X2 Interfaces on eMBMS Handover Failure: Solution and Performance Analysis,” IEEE Transactions on Vehicular Technology, vol. 67, no. 7, pp. 6599-6614, 2018.
[22] K. Vasudeva, M. Simsek, D. Lopez-P′erez, and I. G′uvenc “, “Analysis” of handover failures in heterogeneous networks with fading,” IEEE Transactions on Vehicular Technology, vol. 66, no. 7, pp. 6060-6074, 2016.
[23] X. Xu, Z. Sun, X. Dai, T. Svensson, and X. Tao, “Modeling and analyzing the cross-tier handover in heterogeneous networks,” IEEE Transactions on Wireless Communications, vol. 16, no. 12, pp. 7859-7869, 2017.
[24] S. M. A. Zaidi, M. Manalastas, H. Farooq, and A. Imran, “Syntheticnet: A 3GPP compliant simulator for AI enabled 5G and beyond,” IEEE Access, vol. 8, pp. 82938-82950, 2020.

What is claimed is:

1. A base station, comprising:
an RF transceiver;
a controller/processor communicating with the RF transceiver; and
a non-transitory computer readable medium storing computer executable instructions that, when executed by the processor cause the processor to:
compute a value of a user individual offset parameter for a user equipment;
determine a signal strength and quality measurement corresponding to a signal between the RF transceiver and the user equipment; and
adjust the signal strength and quality measurement with the user individual offset parameter.

2. The base station of claim 1, wherein the user equipment has an identifier and the non-transitory computer readable medium stores computer executable instructions that, when executed by the controller/processor cause the controller/processor to link the user individual offset parameter to the identifier.

3. The base station of claim 2, wherein the non-transitory computer readable medium stores computer executable instructions that, when executed by the controller/processor cause the controller/processor to store the user individual offset parameter in a database.

4. The base station of claim 3, wherein the non-transitory computer readable medium stores computer executable instructions that, when executed by the controller/processor cause the controller/processor to overwrite a previous user individual offset parameter in a database with a new user individual offset parameter.

5. The base station of claim 1, wherein the adjusted signal strength and quality measurement exceeds a handover threshold, and the non-transitory computer readable medium stores computer executable instructions that, when executed by the processor cause the controller/processor to identify that the adjusted signal strength and quality measurement has exceeded the handover threshold and initiate a handover request.

6. The base station of claim 1, wherein the non-transitory computer readable medium stores computer executable instructions that, when executed by the controller/processor cause the controller/processor to optimize the value of the user individual offset parameter to maximize a value of at least one key performance indicator.

7. The base station of claim 6, wherein the at least one key performance indicator is at least one of a group consisting of:
signal to interference and noise ratio;
handover success rate; and
signaling overhead.

8. The base station of claim 1, wherein adjusting the signal strength and quality measurement with the user individual offset parameter is adding the user individual offset parameter to the signal strength and quality measurement or subtracting the user individual offset parameter from the signal strength and quality measurement.

9. A base station, comprising:
an RF transceiver;
a controller/processor communicating with the RF transceiver; and
a non-transitory computer readable medium storing computer executable instructions that, when executed by the processor cause the processor to:
retrieve a value of a user individual offset parameter linked to a user equipment from a database;
determine a signal strength and quality measurement for a signal between the RF transceiver and the user equipment; and
adjust the signal strength and quality measurement with the user individual offset parameter.

10. A method, comprising:
determining a user individual offset parameter for a user equipment;
determining a signal strength and quality measurement corresponding to a signal between an RF transceiver of a base station and the user equipment; and
adjusting the signal strength and quality measurement with the user individual offset parameter.

11. The method of claim 10, further comprising optimizing the user individual offset parameter to maximize at least one key performance indicator.

12. The method of claim 11, wherein the at least one key performance indicator is one of a group consisting of:
signal to interference and noise ratio;
handover success rate; and
signaling overhead.

13. The method of claim 10, wherein adjusting the signal strength and quality measurement with the user individual offset parameter is adding the user individual offset parameter to the signal strength and quality measurement or subtracting the user individual offset parameter from the signal strength and quality measurement.

14. The method of claim 10, further comprising storing the user individual offset parameter in a database.

15. The method of claim 10, wherein the step of determining a user individual offset parameter for a user equipment comprises retrieving the user individual offset parameter from a database.

16. The method of claim 10, wherein the step of determining a user individual offset parameter for a user equipment comprises computing the user individual offset parameter.

17. The method of claim 10, further comprising:
determining that the adjusted signal strength and quality measurement has exceeded a handover threshold; and
initiating a handover request.

18. The method of claim 10, wherein the signal strength and quality measurement is at least one of a group consisting of:
received signal strength indicator;
received signal code power;
reference signal received power;
reference signal received quality; and
signal to interference and noise ratio.

19. A core network, comprising:
an RF transceiver;
a controller/processor communicating with the RF transceiver; and
a non-transitory computer readable medium storing computer executable instructions that, when executed by the processor cause the processor to:
compute a value of a user individual offset parameter for a user equipment;
transmit, via the RF transceiver, the value of the user individual offset parameter to at least one base station.
